(19) United States
(12) Patent Application Publication
(10) Pub. No.: US 2026/0239143 A1
(43) Pub. Date: Aug. 13, 2026

(54) SYSTEM AND METHOD FOR MANAGING SEAMLESS ROAMING IN WIRELESS NETWORK

(71) Applicant: Samsung Electronics Co., Ltd., Suwon-si (KR)

(72) Inventors: Abhishek CHATURVEDI, Bengaluru (IN); Karthik Srinivasa GOPALAN, Bengaluru (IN)

(21) Appl. No.: 19/569,189

(22) Filed: Mar. 17, 2026

Related U.S. Application Data
(63) Continuation of application No. PCT/KR2026/002431, filed on Feb. 10, 2026.

(30) Foreign Application Priority Data
Feb. 11, 2025 (IN) 202541011457
Jan. 12, 2026 (IN) 2025 41011457

(51) Int. Cl. H04W 36/18; H04B 17/309; H04B 17/318; H04L 41/5009; H04W 36/00

(52) U.S. Cl. CPC H04W 36/18; H04B 17/318; H04B 17/346; H04L 41/5009; H04W 36/0061

(57) ABSTRACT

A method performed by a station for managing seamless roaming in a wireless local area network, the method includes detecting, by the station, a trigger for an occurrence of a pre-roaming condition, detecting, by the station, an occurrence of a roaming condition, transmitting, by the station, a roaming request to an access point, wherein the roaming request comprises at least a target access point (AP) identifier (APID) field, a cause field identifying a type of handover, and a serving APID field and an association identifier (AID) field, receiving, by the station, a roaming response from the AP, and resuming, by the station, data transmission session with an identified target AP from the AP.

### CROSS-REFERENCE TO RELATED APPLICATION(S)

This application is a continuation application, claiming priority under 35 U.S.C. § 365 (c), of an International application No. PCT/KR2026/002431, filed on Feb. 10, 2026, which is based on and claims the benefit of an Indian Provisional application number 202541011457, filed on Feb. 11, 2025, in the Indian Intellectual Property Office, and of an Indian Complete patent application No. 202541011457, filed on Jan. 12, 2026, in the Indian Intellectual Property Office, the disclosure of each of which is incorporated by reference herein in its entirety.

### FIELD OF THE INVENTION

The disclosure relates to wireless communication networks. More particularly, the disclosure relates to a system and method for managing seamless roaming in a wireless network.

### BACKGROUND

The information in this section merely provides background information related to the disclosure and may not constitute related art(s) for the disclosure.

Ultra High Reliability standards in wireless fidelity (Wi-Fi) 8 require a standard set of procedures for achieving seamless data roaming. The standards define seamless roaming as a concept of a “non-Access Point (AP) Multi-Link Device (MLD) or station (STA) (client station/device) moving from a serving AP MLD to a target AP MLD such that the client device remains in an authenticated and associated state after the roaming procedure is completed.”.

FIG. 1 is a signal flow diagram illustrating data roaming procedure 100, according to the related art.

Referring to FIG. 1, a data session between a station (STA) and a serving Access Point (AP1) undergoes multiple stages during roaming. The stages include roaming triggering in the data session, roaming initiation, context setup, roaming completion, authentication/association with a target AP2, and establishment of a data session with target AP2.

One of the most crucial aspects of seamless roaming is to preserve and transfer the ongoing data session context to ensure a seamless handoff of data path from serving to target AP Mult-Link Device (MLD) while minimizing the data loss to achieve a near lossless handover. The roaming interruption time between serving AP MLD and target AP MLD requires minimization to less than 10 milliseconds, with an ideal target of zero milliseconds.

Recently, industry standards have established fundamental building blocks for seamless roaming procedures, with detailed specifications pending finalization. Apart from discussions on enhancement to existing baseline roaming procedures such as Fast Transition (FT), another important consensus solution among industry stakeholders introduces a concept of roaming between AP MLDs within a Seamless Mobility Domain (SMD), which incorporates the following criteria, as described below, to support a lossless seamless roaming of the client device.

FIG. 2 is a signal flow diagram illustrating a seamless roaming procedure 200, according to the related art.

The data session between the STA and the serving AP1 undergoes multiple stages during roaming. The stages include roaming trigger in the data session, roaming initiation, context setup, roaming completion, DL data buffer delivery to STA/forwarding to target AP2 and resuming data session with target AP2.

The SMD implementation incorporates multiple criteria for enabling lossless seamless roaming:

Seamless roaming of a client takes place between AP MLDs belonging to (i.e. affiliated to) the same SMD domain.

For lossless data handover between serving and target AP MLDs, some form of data session context needs to be shared-details of which are open to further exploration.

At the time of roaming initiation, for lossless data handover between serving and target AP MLDs, some mechanism needs to be defined to handle the downlink (DL) buffered data at serving AP MLD (which is intended to be delivered to the client).

One of the possible mechanisms to handle DL buffered data is to define a system to forward this buffered data from the serving AP MLD to the target AP MLD and then to be delivered to the intended roaming client.

Also, in order to perform the roaming procedure-related signalling quickly (before the serving AP MLD is lost), there are discussions ongoing to have some form of roaming preparation in place so that some static configurations can be handled in advance before the actual roaming is triggered.

Industry discussions regarding SMD architecture and variants, particularly, have led to a common understanding of approaches to architecture. These approaches include two distinct architectural variants for SMD roaming as discussed below with respect to FIGS. 3 and 4.

FIG. 3 illustrates the SMD roaming architecture with different Medium Access Control-Service Access Point (MAC-SAP) 300, according to the related art.

The related art discloses different MAC-SAP for each non-collocated AP MLD within the SMD. Each MAC-SAP connects to a Distributed System (DS, AP backend) for facilitating roaming between associated AP MLDs.

FIG. 4 illustrates the SMD roaming architecture with a single MAC-SAP 400, according to the related art.

SMD roaming architecture with a single MAC-SAP utilizes a single MAC-SAP implementation exposed to DS for the entire SMD. The single MAC-SAP architecture enables roaming between non-collocated AP MLDs within an SMD.

Further, timely handling of buffered downlink (DL) data enables near lossless handover, with significant implications for multiple use cases:
Application usability of buffered data in non-real-time scenarios such as file downloads and buffered audio/video;
Transmission Control Protocol (TCP) congestion window management is affected by data packet dropping; and
Video I-frame preservation requirements for subsequent P-frame rendering.

Based on roaming trigger (such as rate of roaming-trigger Key Performance Indicators (KPI), including Received Signal Strength Indicator (RSSI) and Signal-to-Interference-plus-Noise Ratio (SINR) drop at serving AP MLD) and its associated rate of drop of roaming KPI, the entire roaming scenarios can be categorized into following categories:
Normal RSSI drop: When the rate of drop provides enough time to complete roaming signalling as well as retrieve some buffered DL data from serving AP MLD before moving to the target AP MLD completely;
Fast RSSI drop: When the rate of drop provides just enough time to complete roaming signalling but no time for buffered DL data retrieval from serving AP MLD;
Panic RSSI drop: When the rate of drop is so drastic that there is not even enough time to complete roaming related signalling procedure and serving AP MLD is lost beforehand.

Thus, there is a need to define a mechanism to handle the buffered DL data for all such cases for best-case data recovery during seamless roaming.

IEEE draft reference PDT #1881 37.12.6 Data forwarding [M #27] specifies that as a part of seamless roaming, the current AP MLD may forward DL data to the target AP MLD. However, when and how to initiate the forwarding of DL data is not yet defined.

Therefore, there exists a need for systems and methods to seamless roaming while overcoming the above mentioned problems.

The above information is presented as background information only to assist with an understanding of the disclosure No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a system and method for managing seamless roaming in a wireless network.

Additional aspects will be set forth in part in the description which follows and, in part, will be apparent from the description, or may be learned by practice of the presented embodiments.

In accordance with an aspect of the disclosure, the method performed by a station for managing seamless roaming in a wireless network is provided. The method includes detecting, by the station, a trigger for an occurrence of a pre-roaming condition, detecting, by the station, an occurrence of a roaming condition, transmitting, by the station, a roaming request to an access point, wherein the roaming request includes at least a target access point (AP) identifier (APID) field, a cause field identifying a type of handover, and a serving APID field and an association identifier (AID) field, receiving, by the station, a roaming response from the AP, and resuming, by the station, data transmission session with an identified target AP from the AP.

In accordance with another aspect of the disclosure, a method performed by a serving access point for managing seamless roaming in a area network, is provided. The method includes detecting, by the serving AP, a trigger for an occurrence of a pre-roaming condition, storing, by the serving AP, downlink data packet associated with a station, in a data buffer associated to one or more potential target APs such that the downlink data packet may be forwarded from the data buffer, receiving, by the serving AP, a roaming request from the station, wherein the roaming request identifies a type of handover and includes at least a target AP identifier (APID) field, a cause field identifying the type of handover, a serving APID field and an association identifier (AID) field, transferring, by the serving AP, a station context transfer information associated with the station to an identified target AP from the one or more potential target APs based on establishing data session context transfer with the identified target AP, and transmitting, by the serving AP, a roaming response to the station.

In accordance with another aspect of the disclosure, a method performed by an identified access point (AP) for managing seamless roaming in a wireless network, is provided. The method includes receiving, by the identified AP, a station context transfer information associated with a station and an indication of a handover, fetching, by the identified AP, a downlink data packet stored in a data buffer by a serving AP, and resuming, by the identified AP, a downlink data packet transmission with the station based on the fetching.

In accordance with another aspect of the disclosure, a system for managing seamless roaming in a wireless network by a station, is provided. The system includes memory including one or more storage media, storing instructions, and at least one processor communicatively coupled to the memory, wherein the instructions, when executed by the at least one processor individually or collectively, cause the system to detect a trigger for an occurrence of a pre-roaming condition, detect an occurrence of a roaming condition, transmit a roaming request to an access point, wherein the roaming request includes at least a target access point (AP) identifier (APID) field, a cause field identifying a type of handover, a serving APID field and an association identifier (AID) field, receive a roaming response from the AP, and resume data transmission session with an identified target AP from the AP.

In accordance with another aspect of the disclosure, a system for managing seamless roaming in a wireless network by a serving access point (AP), is provided. The system includes memory including one or more storage media, storing instructions, and at least one processor communicatively coupled to the memory, wherein the instructions, when executed by the at least one processor individually or collectively, cause the system to detect a trigger for an occurrence of a pre-roaming condition, store downlink data packet associated with a station, in a data buffer associated to one or more potential target APs such that the downlink data packet may be forwarded from the data buffer, receive a roaming request from the station, wherein the roaming request identifies a type of handover and includes at least a target AP identifier (APID) field, a cause field identifying the type of handover, a serving APID field and an association identifier (AID) field, transfer a station context transfer information associated with the station to an identified target AP from the one or more potential target APs based on establishing data session context transfer with the identified target AP, and transmit a roaming response to the station.

In accordance with another aspect of the disclosure, a system for managing seamless roaming in a wireless network by an identified access point (AP), is provided. The system includes memory including one or more storage media, storing instructions, and at least one processor communicatively coupled to the memory, wherein the instructions, when executed by the at least one processor individually or collectively, cause the system to: receive a station context transfer information associated with a station and an indication of a handover, fetch a downlink data packet stored in a data buffer by a serving AP, and resume a downlink data packet transmission with the station based on the fetching.

In accordance with another aspect of the disclosure, one or more non-transitory computer-readable storage media storing one or more computer programs including computer-executable instructions that, when executed by at least one processor of a station individually or collectively, cause the station to perform operations are provided. The operations include detecting, by the station, a trigger for an occurrence of a pre-roaming condition, detecting, by the station, an occurrence of a roaming condition, transmitting, by the station, a roaming request to an access point, wherein the roaming request includes at least a target access point (AP) identifier (APID) field, a cause field identifying a type of handover, and a serving APID field and an association identifier (AID) field, receiving, by the station, a roaming response from the AP, and resuming, by the station, data transmission session with an identified target AP from the AP.

Other aspects, advantages, and salient features of the disclosure will become apparent to those skilled in the art from the following detailed description, which taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a signal flow diagram illustrating data roaming procedure, according to the related art;

FIG. 2 is a signal flow diagram illustrating seamless roaming procedure, according to the related art;

FIG. 3 illustrates Seamless Mobility Domain (SMD) roaming architecture with different Medium Access Control-Service Access Point (MAC-SAP), according to the related art;

FIG. 4 illustrates SMD roaming architecture with a single MAC-SAP, according to the related art;

FIG. 5 illustrates an environment having a station, a serving Access Point (AP) and an identified Access Point (AP), according to an embodiment of the disclosure;

FIGS. 6A and 6B illustrate a block diagram of each of the station, the serving AP, and the identified AP, according to various embodiments of the disclosure;

FIG. 7 illustrates an operation performed by the station, according to an embodiment of the disclosure;

FIG. 8 illustrates a schematic diagram depicting a timeline comparison between a trigger for an occurrence of a pre-roaming condition and an occurrence of a roaming condition, according to an embodiment of the disclosure;

FIG. 9 illustrates an operation performed by the serving AP, according to an embodiment of the disclosure;

FIG. 10 illustrates a schematic diagram illustrating the data buffer copying mechanism between access points through a common Media Access Control (MAC) buffer, according to an embodiment of the disclosure;

FIG. 11 illustrates a schematic diagram illustrating a distributed data buffer copying mechanism, according to an embodiment of the disclosure;

FIG. 12 illustrates an operation performed by the identified AP, according to an embodiment of the disclosure;

FIG. 13 illustrates a signal flow diagram providing a pre-roaming trigger evaluation at the station (STA), according to an embodiment of the disclosure;

FIG. 14 illustrates a signal flow diagram providing pre-roaming trigger evaluation at the serving AP, according to an embodiment of the disclosure;

FIG. 15 illustrates a signal flow diagram indicating buffer handling procedures during normal Received Signal Strength Indicator (RSSI) drop scenarios, according to an embodiment of the disclosure;

FIG. 16 illustrates a signal flow diagram indicating buffer handling procedures during fast RSSI drop scenarios, according to an embodiment of the disclosure;

FIG. 17 illustrates a signal flow diagram indicating buffer handling procedures during panic RSSI drop scenarios, according to an embodiment of the disclosure;

FIG. 18 illustrates a flowchart of a method performed by the STA, according to an embodiment of the disclosure;

FIG. 19 illustrates a flowchart of a method performed by the serving AP, according to an embodiment of the disclosure; and

FIG. 20 illustrates a flowchart of a method performed by the identified AP, according to an embodiment of the disclosure.

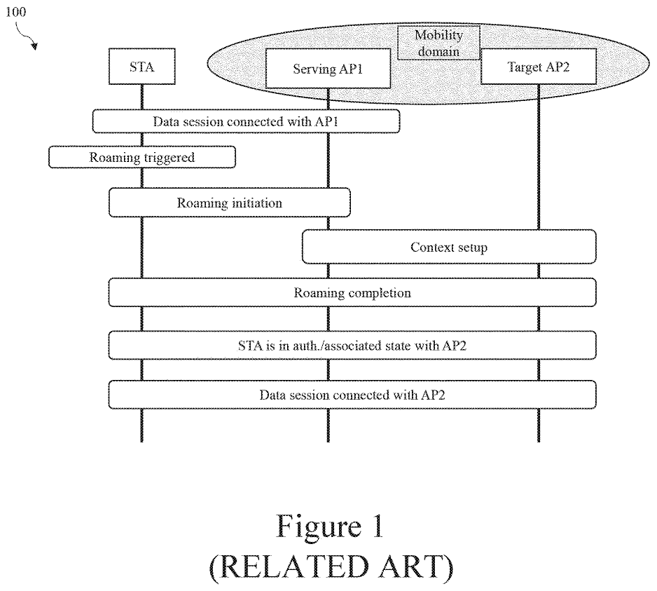

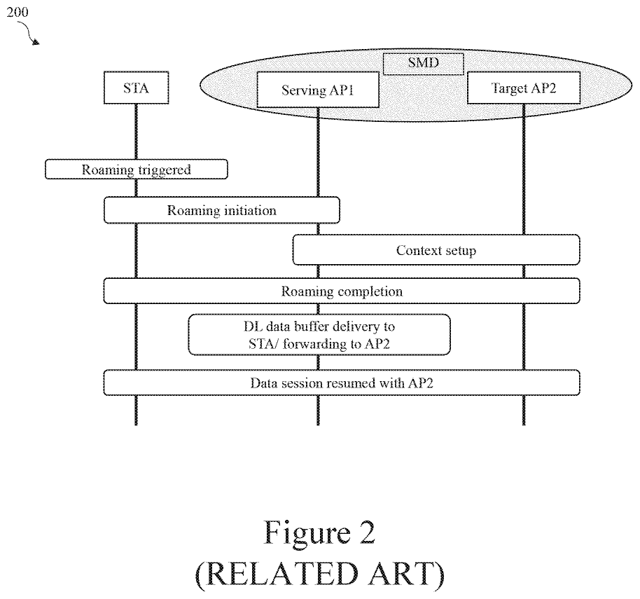

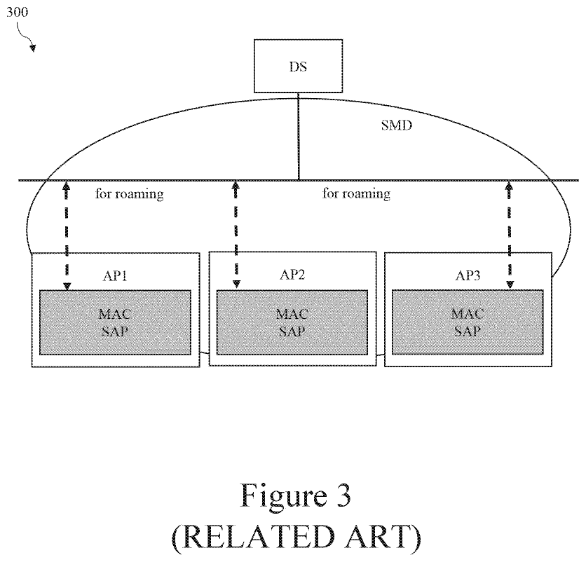

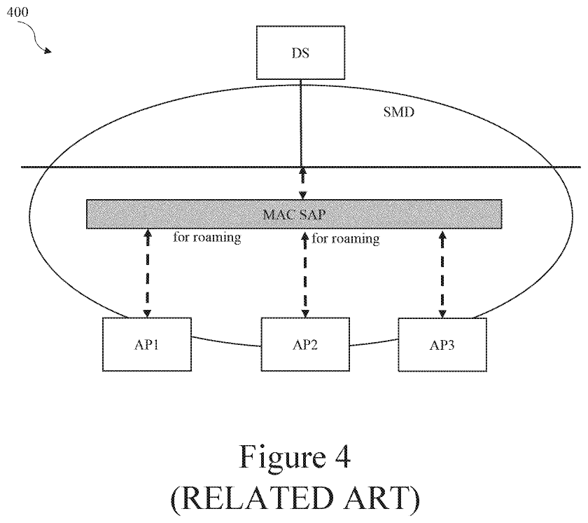

The same reference numerals are used to represent the same elements throughout the drawings.

### DETAILED DESCRIPTION OF FIGURES

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It will be understood by those skilled in the art that the foregoing general description and the following detailed description are explanatory of the disclosure and are not intended to be restrictive thereof.

Whether or not a certain feature or element was limited to being used only once, it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language including, but not limited to, “there needs to be one or more . . . ” or “one or more elements is required.” The phrase “at least one of,” when used with a list of items, means that different combinations of one or more of the listed items may be used, and only one item in the list may be needed. For example, “at least one of: A, B, and C” includes any of the following combinations: (1) A, (2) B, (3) C, (4) A and B, (5) A and C, (6) B and C, and (7) A and B and C. For example, “at least one of: A, B, or C” includes any of the following combinations: (1) A, (2) B, (3) C, (4) A and B, (5) A and C, (6) B and C, and (7) A and B and C. The phrase “one or more of,” when used with a list of items, means that different combinations of one or more of the listed items may be used, and only one item in the list may be needed. For example, “one or more of: A, B, and C” includes any of the following combinations: (1) A, (2) B, (3) C, (4) A and B, (5) A and C, (6) B and C, and (7) A and B and C″. For example, “one or more of: A, B, or C” includes any of the following combinations: (1) A, (2) B, (3) C, (4) A and B, (5) A and C, (6) B and C, and (7) A and B and C.

Reference is made herein to some “embodiments.” It should be understood that an embodiment is an example of a possible implementation of any features and/or elements of the disclosure. Some embodiments have been described for the purpose of explaining one or more of the potential ways in which the specific features and/or elements of the proposed disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not necessarily be taken as limiting factors to the proposed disclosure.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

In an embodiment, the disclosure discloses a system and method of handling buffered data using pre-roaming operations.

A data connection established on a serving Access Point Multi-Link Device (AP MLD) may initiate pre-roaming operations. The pre-roaming operations may comprise a pre-roaming trigger mechanism and a downlink (DL) data buffer copying mechanisms.

Particularly, seamless roaming operations face critical timing constraints when serving access points undergo rapid degradation. Under rapid degradation conditions, associated clients risk losing connection to serving access points before completing the necessary context exchanges successfully. Further, in rapid degradation conditions, the backend data path routing configurations, and buffered data forwarding to target access points, with all their related message signalling, may also not take place successfully. Such incomplete transfers result in extended delays during re-association with target access points and potential loss of context and data during transition periods.

The disclosure provides solutions implementing pre-roaming preparations executed prior to actual roaming events. Pre-roaming preparations reduce signalling exchange burdens and data forwarding complexities during actual roaming events, thereby increasing successful handover probability.

The disclosure implements two primary pre-roaming mechanisms: the pre-roaming trigger mechanism, and DL data buffer copying mechanisms.

In an embodiment, the pre-roaming trigger mechanism may comprise:
OPTION 1: Pre-roaming trigger implementation at client/Station (STA); and
OPTION 2: Pre-roaming trigger implementation at serving Access Point (AP).

In an embodiment, the DL data buffer copying mechanism for preventing data loss during serving AP MLD to target AP MLD transitions may comprise:
OPTION 1: Implementation of DL data buffer copying from serving AP MLD to common Medium Access Control (MAC) buffer at Seamless Mobility Domain (SMD) level prior to roaming procedure initiation; and
OPTION 2: Implementation of DL data buffer copying from serving AP MLD to MAC buffers of individual potential target AP MLDs prior to roaming procedure initiation.

Embodiments of the disclosure will be described below in detail with reference to the accompanying drawings.

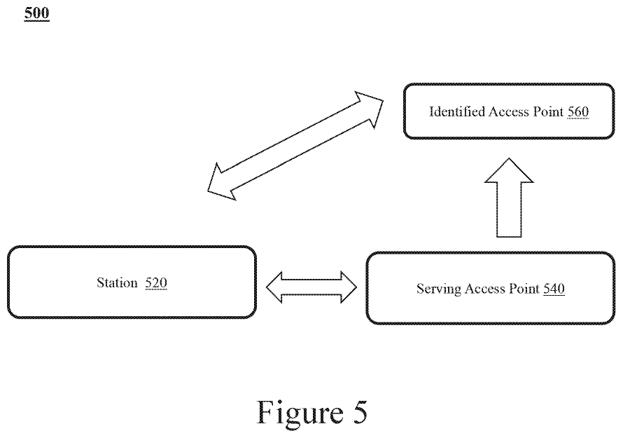

FIG. 5 illustrates an environment 500 having a station 520, a serving Access Point (AP) 540, and an identified Access Point (AP) 560, according to an embodiment of the disclosure.

In an embodiment, in a wireless network, the station (STA) 520 may be a client device, such as a smartphone, laptop, or tablet, that connects to a network to send and receive data. The serving access point (AP) 540 may be a specific access point to which the STA 520 is currently associated with and through which the STA 520 communicates at that moment. Further, to enable seamless roaming, the network also maintains one or more potential target APs, which are nearby APs recognized by the STA 520 and the network as potential handoff targets. As the STA 520 moves and signal conditions change, the STA 520 may smoothly transition from the serving AP to the identified AP 560 from among the one or more potential target APs without noticeable interruption, maintaining continuous connectivity and performance.

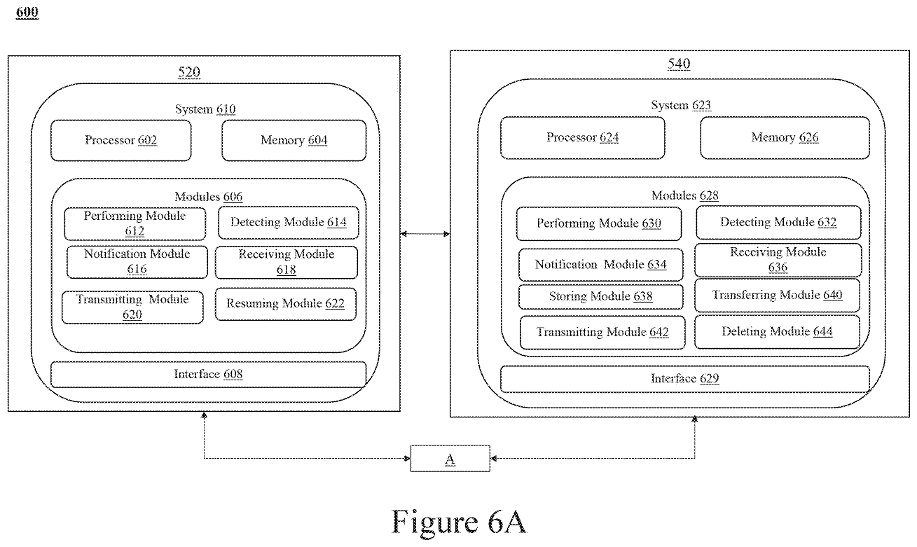

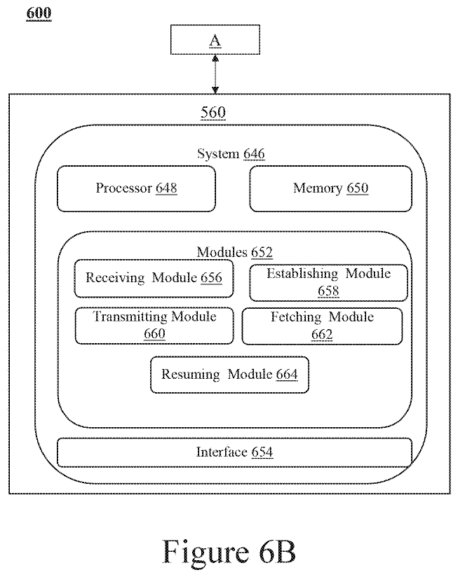

FIGS. 6A and 6B illustrate an environment 600 including systems 610, 623, and 646 for managing seamless roaming in a wireless network, according to various embodiments of the disclosure. As shown, the environment 600 may include a system 610 corresponding to the STA 520. In the examples discussed below, STA 520 is a non-access point (AP) multi-link device (MLD). However, STAs come in a wide variety of configurations, and FIG. 6A does not limit the scope of this disclosure to any particular implementation of a STA. The system 610 is connected to a system 623 corresponding to the serving AP 540. The serving AP 540 can be called a current AP. Further, each of the system 610, and system 623 is connected to the system 646 corresponding to the identified target AP 560.

The system 610 may include one or more processors 602 (hereinafter referred to as the processor 602), a memory 604, modules 606, and an interface 608. In an embodiment, the one or more processors 602 may be in communication with the memory 604, the modules 606, and the interface 608.

In one embodiment, the processor 602 can include processing circuitry, which can be implemented by a circuit. The processor 602 may include at least one data processor for executing processes in Virtual Storage Area Network. The processor 602 may include specialized processing units such as integrated system (bus) controllers, memory management control units, floating point units, graphics processing units, digital signal processing units, etc. In one embodiment, the processor 602 may include a Central Processing Unit (CPU), a Graphics Processing Unit (GPU), or both. The processor 218 may be one or more general processors, Digital Signal Processors (DSPs), application-specific integrated circuits, Field-Programmable Gate Arrays (FPGAs), servers, networks, digital circuits, analog circuits, combinations thereof, or other now known or later developed devices for analyzing and processing data. The processor 602 may execute a software program, such as code generated manually (i.e., programmed) to perform the desired operation. The processor 602 may implement various techniques such as, but not limited to, image processing, data extraction, Artificial Intelligence (AI), Machine Learning (ML), Deep Learning (DL), and so forth to achieve the desired objective.

In one embodiment, the processor 602 may be configured to perform the functions of the system 610/the STA 520.

The processor 602 may be disposed in communication with one or more Input/Output (I/O) devices, such as the systems 623 and 646, via the interface 608. The interface 608 may employ communication Code-Division Multiple Access (CDMA), High-Speed Packet Access (HSPA+), Global System For Mobile Communications (GSM), Long-Term Evolution (LTE), WiMax, or the like, etc.

In an embodiment, the processor 602 may be disposed in communication with a communication network via a network interface. In an embodiment, the network interface may be the interface 608. The network interface may connect to the communication network to enable connection of the system 610 with the outside environment and/or device/system. The network interface may employ connection protocols including, without limitation, direct connect, Ethernet (e.g., twisted pair 10/100/1000 Base T), Transmission Control Protocol/Internet Protocol (TCP/IP), token ring, IEEE 802.11/b/g/n/x, etc. The communication network may include, without limitation, a direct interconnection, Local Area Network (LAN), Wide Area Network (WAN), wireless network (e.g., using Wireless Application Protocol (WAP)), the Internet, etc. Using the network interface and the communication network, the system 610 may communicate with other devices. The network interface may employ connection protocols including, but not limited to, direct connect, Ethernet (e.g., twisted pair 10/100/1000 Base T), TCP/IP, token ring, IEEE 802.11/b/g/n/x, etc.

The memory 604 may be communicatively coupled to the processor 602. The memory 604 stores instructions that, when executed by the at least one processor 602 individually or collectively, cause the STA 520 to perform the methods and/or the operations described herein. The memory 604 may be configured to store data and instructions executable by the processor 602. In one embodiment, the memory 604 may communicate via a bus within the system 610. The memory 604 may include, but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 604 may include a cache or random-access memory for the processor 602. In alternative examples, the memory 604 is separate from the processor 602, such as a cache memory of a processor, the system memory, or other memory. The memory 604 may be an external storage device or database for storing data. The memory 604 may be operable to store instructions executable by the processor 602. The functions, acts, or tasks illustrated in the figures or described may be performed by the programmed processor 602 for executing the instructions stored in the memory 604. The functions, acts, or tasks are independent of the particular type of instruction set, storage media, processor, or processing strategy and may be performed by software, hardware, integrated circuits, firmware, micro-code, and the like, operating alone or in combination. Likewise, processing strategies may include multiprocessing, multitasking, parallel processing, and the like. The memory 604 may further include a database to store the data. Further, the memory 604 may include an operating system for performing one or more tasks of the system 610, as performed by a generic operating system in the communications domain.

For the sake of brevity, the architecture, and standard operations of the processor 602 and the memory 604 are not discussed in detail. In one embodiment, the memory 604 may be configured to store the information as required by the processor 602 to perform the techniques described herein.

The modules 606, amongst other things, include routines, programs, objects, components, data structures, etc., which perform particular tasks or implement data types. The modules 606 may also be implemented as, signal processor(s), state machine(s), logic circuitries, and/or any other device or component that manipulates signals based on operational instructions. The modules 606 may be configured to one or more operations of the system 610 and/or the processor 602. The modules 606 may be controlled or implemented by the processor 602. The modules 606 may be integrated into the processor 602.

Further, the modules 606 can be implemented in hardware, instructions executed by a processing unit, or by a combination thereof. The processing unit can comprise a computer, the processor 602, a state machine, a logic array, or any other suitable devices capable of processing instructions. The processing unit can be a general-purpose processor which executes instructions to cause the general-purpose processor to perform the required tasks, or the processing unit can be dedicated to performing the required functions. In another embodiment of the disclosure, the modules 606 may be machine-readable instructions (software) that, when executed by a processor/processing unit, perform any of the described functionalities. Furthermore, the data serves, amongst other things, as a repository for storing data processed, received, and generated by one or more of the modules. The modules 606 may include a performing module 612, a detecting module 614, a notification module 616, a receiving module 618, a transmitting module 620, and a resuming module 622. Each module may be in communication with each other. Each module may be in communication with the processor 602.

In an embodiment, the system 623 may include one or more processors 624 (hereinafter referred to as the processor 624), a memory 626, modules 628, and an interface 629. The one or more processors 624 can include processing circuitry, which can be implemented by a circuit. The memory 626 stores instructions that, when executed by the at least one processor 624 individually or collectively, cause the serving AP 540 to perform the methods and/or the operations described herein. The constructional and operation details of each of the processor 624, the memory 626, the modules 628, and the interface 629 may be same as the constructional and operation details of each of the processor 602, the memory 604, the modules 606, and the interface 608 as explained earlier. Thus, the same has not been explained for the sake of brevity. Further, the modules 628 may include a preforming module 630, a detecting module 632, a notification module 634, a receiving module 636, a storing module 638, a transferring module 640, a transmitting module 642, and a deleting module 644. Herein, each module may be in communication with each other. Further, each module may be in communication with the processor 624. The modules 628 may be controlled or implemented by the processor 624. The modules 628 may be integrated into the processor 624.

In an embodiment, the system 646 may include one or more processors 648 (hereinafter referred to as the processor 648), a memory 650, modules 652, and an interface 654. The one or more processors 648 can include processing circuitry, which can be implemented by a circuit. The memory 650 stores instructions that, when executed by the at least one processor 648 individually or collectively, cause the target AP 560 to perform the methods and/or the operations described herein. The constructional and operation details of each of the processor 648, the memory 650, the modules 652, and the interface 654 may be same as the constructional and operation details of each of the processor 602, the memory 604, the modules 606, and the interface 608 as explained earlier. Thus, the same has not been explained for the sake of brevity. Further, the modules 652 may include a receiving module 656, an establishing module 658, a transmitting module 660, a fetching module 662, and a resuming module 664. Herein, each module may be in communication with each other. Further, each module may be in communication with the processor 648.

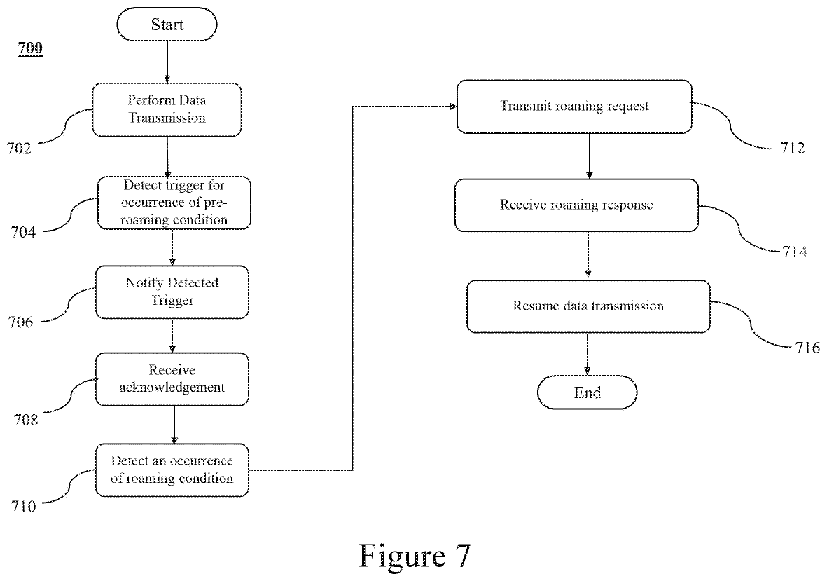

FIG. 7 illustrates an operation performed by the STA 520, according to an embodiment of the disclosure.

In an embodiment, at operation 702, the performing module 612 may be configured to perform data transmission with the serving AP 540.

At operation 704, the detecting module 614 may be configured to detect a trigger for an occurrence of a pre-roaming condition.

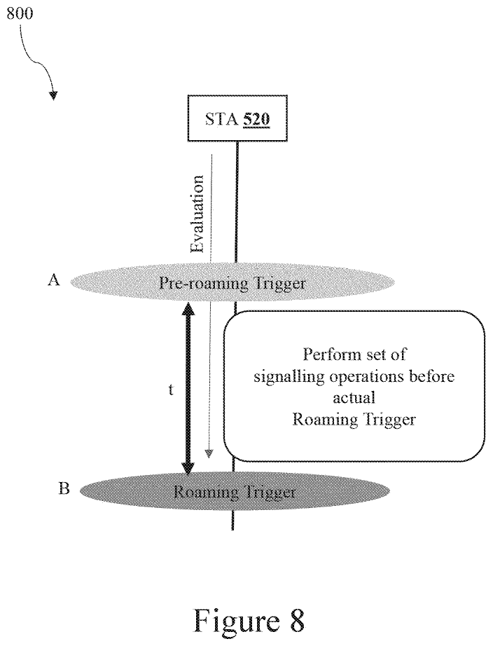

Herein, the detecting module 614 may be configured to monitor a value of a Key Performance Indicator (KPI) of the serving AP 540. The KPI may indicate Received Signal Strength Indicator (RSSI) of Signal-to-Interference & Noise Ratio (SINR) observed between the serving AP 540 and the station 520. Thereafter, the detecting module 614 may be configured to compare the value with a predetermined threshold value. Further, the detecting module 614 may be configured to detect the trigger for the occurrence of the pre-roaming condition, when the value of the KPI is equal to or less than the predetermined threshold value (explained in the subsequent paragraphs in conjunction with FIG. 8).

At operation 706, the notification module 616 may be configured to notify the detected trigger to the serving AP 540.

At operation 708, the receiving module 618 may be configured to receive an acknowledgement of the notification from the serving AP 540.

At operation 710, the detecting module 614 may be configured to detect an occurrence of a roaming condition. This configuration reduces the time associated with a handover once the roaming condition has occurred.

At operation 712, the transmitting module 620 may be configured to transmit a roaming request to an access point. Herein, the access point may include at least one of the serving AP 540 and the identified target AP 560 from among the one or more potential target APs. Further, the roaming request may include at least a target AP identifier (APID) field, a cause field identifying a type of handover, a serving APID field and an association identifier (AID) field. Herein, the type of handover indicates one of a normal handover, a fast handover, and a panic handover.

Herein, the transmitting module 620 may be configured to transmit the roaming request to the serving AP 540, when the type of the handover indicates one of the normal handover and the fast handover. Further, the transmitting module 620 may be configured to transmit the roaming request to the identified target AP 560, when the type of the handover indicates the panic handover.

The roaming request indicates cause: fast_RSSI_drop value, when the type of handover indicates the fast handover.

At operation 714, the receiving module 618 may be configured to receive a roaming response from the AP.

Herein, the receiving module 618 may be configured to receive the roaming response from the serving AP 540, when the type of the handover indicates one of the normal handover and the fast handover. The receiving module 618 may be configured to receive the roaming response from the identified target AP 560, when the type of the handover indicates the panic handover.

The roaming response may include link(s) configuration with the identified target AP 560 after a context transfer and backend distribution system (DS) path update between the serving AP 540 and the identified target AP 560. Further, the roaming response may be followed by a conditional wait time period, when the type of the handover is the normal handover. Thereafter, the detecting module 614 may be configured to detect a connection closure condition from the serving AP 540 upon expiration of the conditional wait time period, followed by resumption of the data transmission with the identified target AP 560.

At operation 716, the resuming module 622 may be configured to resume a data transmission session with the identified target AP 560.

FIG. 8 illustrates a schematic diagram 800 depicting a timeline comparison between the trigger for the occurrence of the pre-roaming condition and the occurrence of the roaming condition, according to an embodiment of the disclosure.

In an embodiment, the occurrence of the roaming condition may include evaluation criteria, typically implemented at the STA 520. Herein, when the detecting module 614 detects the occurrence of the roaming condition, then a roaming-related signalling procedure for the STA 520 for transitioning from the serving AP 540 to the identified target AP 560 may be initiated.

Herein, criteria for the occurrence of the roaming condition may be primarily based on a stable rate of variations in the relevant Key Performance Indicators (KPIs) of the serving AP 540.

Referring to FIG. 8, at point B, rate variation in the KPI may be denoted as R, while the threshold value is denoted as V, and the time duration required for completion of pre-roaming operations may be denoted as t milliseconds.

The disclosure introduces the pre-roaming trigger concept, depicted in FIG. 8 at point A. The pre-roaming trigger may occur prior to the occurrence of the roaming condition, enabling execution of pre-roaming operations or roaming preparation procedures as detailed in subsequent paragraphs. Further, criteria for the occurrence of the pre-roaming trigger may be primarily based on a stable rate of variations in the relevant Key Performance Indicators (KPIs) of the serving AP 540. Herein, the KPIs may include the signal strength (Received Signal Strength Indicator (RSSI) drop) or signal quality (Signal-to-Interference-plus-Noise Ratio (SINR) drop based on level of interference). Further, the roaming condition may occur when the KPI drops to the predetermined threshold value. Additionally, there may be other intricate level parameters in action during the evaluation.

Further, the time taken to complete a set of pre-roaming operations (explained in the later paragraphs) is t ms.

The relationship between the pre-roaming trigger threshold and an actual Roaming Trigger threshold may be as shown in equation 1.

$${V}_{A} - {V}_{B} = R \times ( t + delta ) \qquad Equation 1$$

where: VA represents pre-roaming trigger threshold; VB represents Roaming Trigger threshold; R represents KPI variation rate; t represents pre-roaming operation completion time; delta represents additional signal processing delay duration.

The pre-roaming trigger mechanism enables the execution of predefined operations prior to the occurrence of the roaming condition, ensuring expedited and lossless transitions during the occurrence of the roaming condition, even during rapid degradation of the serving AP 540.

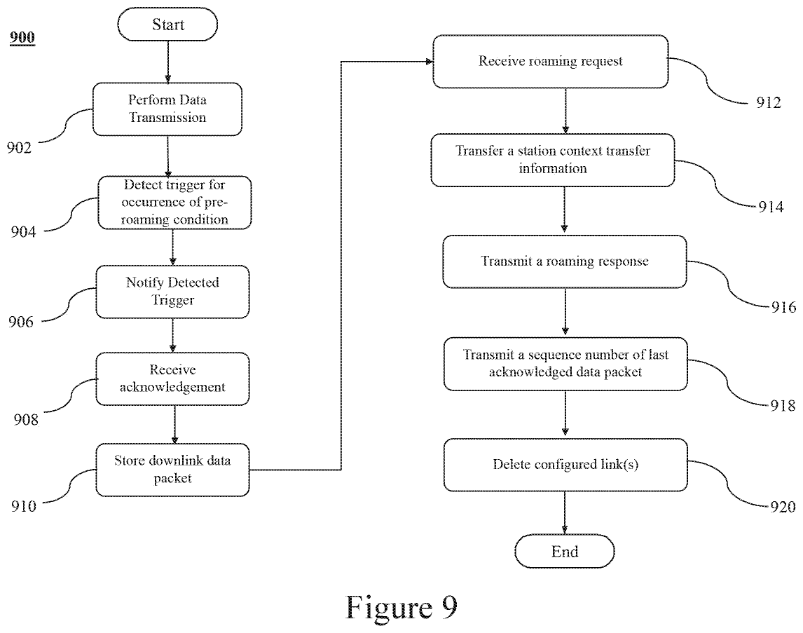

FIG. 9 illustrates an operation 900 performed by the serving AP 540, according to an embodiment of the disclosure.

In an embodiment, at operation 902, the performing module 630 may be configured to perform data transmission with the STA 520.

At operation 904, the detecting module 632 may be configured to detect the trigger for the occurrence of the pre-roaming condition.

In such an embodiment, the detecting module 632 may be configured to monitor the value of the KPI. Herein, the KPI may indicate RSSI or SINR observed between the serving AP 540 and the STA 520. Further, the detecting module 632 may be configured to compare the value with the predetermined threshold value. The detecting module 632 may be configured to detect the trigger for the occurrence for the pre-roaming condition, when the value of the KPI is equal to or less than the predetermined threshold value.

At operation 906, the notification module 634 may be configured to notify the detected trigger to the STA 520. Further, at operation 908, the receiving module 636 may be configured to receive an acknowledgement of the notification from the STA 520.

At operation 910, the storing module 638 may be configured to store downlink data packet associated with the STA 520 in a data buffer associated with the one or more potential target APs such that the downlink data packet may be forwarded in the data buffer. Further, the operation as performed by the storing module 638 may be termed as a set of pre-roaming operations, without departing from the scope of the disclosure.

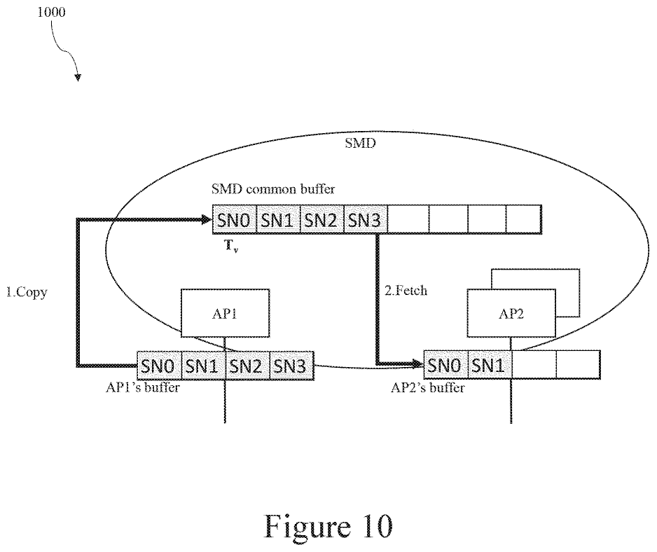

Herein, the storing module 638 may be configured to store the downlink data packet in the data buffer for a predetermined time period such that the data buffer may be common for each of the serving AP 540 and the one or more potential target APs. The data buffer, along with the serving AP 540 and the one or more potential target APs forms part of a common Seamless Mobility Domain (SMD) (explained in detail in the subsequent paragraphs with respect to FIG. 10). Thereafter, the storing module 638 may be configured to delete the forwarded downlink data from the data buffer after expiration of a predetermined time period.

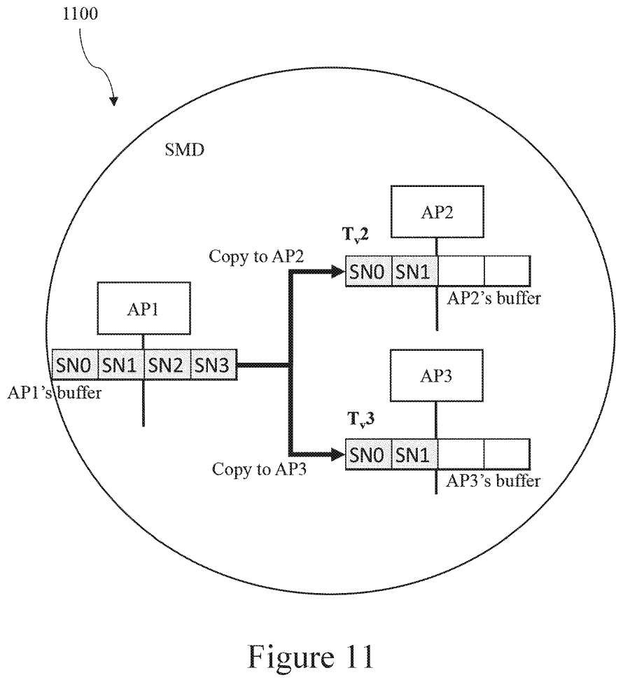

Further, the storing module 638 may be configured to store the downlink data packet in the data buffer corresponding to each of the one or more potential target APs for the predetermined time period (explained in detail in the subsequent paragraphs with respect to FIG. 11). Herein, the data buffer along with the serving AP 540 and the one or more potential target APs forms part of the common Seamless Mobility Domain (SMD).

At operation 912, the receiving module 636 may be configured to receive the roaming request from the STA 520. The roaming request may identify the type of handover. Further, the roaming request may include at least the target AP identifier (APID) field, the cause field identifying the type of handover, the serving APID field and the association identifier (AID) field. Herein, the type of the handover may indicate the normal handover, the fast handover, and the panic handover.

Herein, the receiving module 636 may be configured to receive the roaming request from the STA 520, when the type of the handover indicates one of the normal handover and the fast handover. The roaming request may indicate cause: fast_RSSI_drop value, when the type of handover indicates the fast handover.

At operation 914, the transferring module 640 may be configured to transfer a station context transfer information associated with the STA 520 to the identified target AP 560. The transferring module 640 may be configured to transfer the station context transfer based on establishing a data session context transfer with the identified target AP 560.

At operation 916, the transmitting module 642 may be configured to transmit the roaming response to the STA 520.

Herein, the transmitting module 642 may be configured to transmit the roaming response to the STA 520, when the type of the handover indicates one of the normal handover and the fast handover. The roaming response may indicate the link transmitting the roaming response to the station 520, when the type of the handover indicates one of the normal handover and the fast handover. The roaming response indicates the link(s) configuration with the identified target AP 560 after the context transfer and backend distribution system (DS) path update between the serving AP 540 and the identified target AP 560.

Further, the transmitting module 642 may be configured to transmit the roaming response followed by a conditional wait time period, when the type of the handover may be the normal handover.

Herein, the transmitting module 642 may be configured to transmit the roaming response along with the deletion of the configured link(s) with the STA 520, when the type of handover is the fast handover.

In an embodiment, upon transmitting the roaming response followed by the conditional wait time, at operation 918, the transmitting module 642 may be configured to transmit a sequence number of the last acknowledged data packet from the downlink data packet to the identified target AP 560. The transmitting module 642 may be configured to transmit the sequence number upon expiry of the conditional wait time period. Further, at operation 920, the deleting module 644 may be configured to delete a configured link(s) with the station 520 upon one of the expiration of the conditional wait time period and transmitting the roaming response. In an embodiment, the details of the conditional wait time period may be provided as below:
In the case of the seamless roaming scenario with normal KPI/RSSI drop, the systems 610, 623 may allocate sufficient time for completing roaming-related signalling procedures with stakeholders and facilitating STA transfer to the identified target AP 560 while maintaining the serving AP 540 connectivity.

In an embodiment, following the storing of the downlink data packet and Roaming Request/Response signalling procedures, the serving AP 540 may execute the conditional wait time period. The conditional wait time period may indicate an option at the serving AP 540 for a duration for which the serving AP 540 may continue the buffered DL data transmission towards the STA 520 before deleting the link(s) (with STA). Further, notifying the identified target AP 560 about the last ACKed SN for the data packet for the identified target AP 560 to resume further data handling.

The conditional wait time period at the serving AP 540 may comprise the following set of criteria:

The serving AP 540 may maximize buffered data delivery to the STA 520 while maintaining operations within sustainable RSSI limits, maintaining acknowledgement KPI, and minimizing data loss or retransmissions.

The serving AP 540 may reduce the identified target AP 560 buffer data fetching efforts by minimizing the amount of buffered data requiring fetch and transmission operations.

The serving AP 540 may reduce duplicate handling and retransmission delays at the identified target AP 560 through successful transfer and acknowledgement of buffered data segments via the serving AP transmissions.

The serving AP 540 may provide a longer time duration for the identified target AP 560 to acquire channel resources during congestion or contention scenarios.

In cases involving STA uplink (UL) data transmission requirements, the serving AP 540 may prioritize STA transmission needs and expedite data handling transfer to the identified target AP 560. Thus, the STA 520 may resume communication with the identified target AP 560.

Herein, the conditional wait time period may be computed based on the following factors:

As RSSI/SNR degrades, the time required to reach a predefined RSSI threshold may be used as one criterion to compute the conditional wait time period.

As RSSI/SNR continues to fall, thereby increasing retransmissions.

Further, the time until the retransmission rate exceeds a predefined retransmission rate, may be another criterion to compute the conditional wait time period.

Further, the transmitting module 642 may be configured to transmit a request to the identified target AP 560 to resume the complete downlink data packet transmission with the STA 520.

FIG. 10 illustrates a schematic diagram 1000 providing the data buffer copying mechanism between the APs through a common MAC buffer, according to an embodiment of the disclosure. The diagram depicts AP1's buffer, SMD common buffer, target AP2's buffer, and the sequence numbers (SN0-SN3) representing buffered data packets.

In an embodiment, the SMD implementation with MAC Service Access Point (SAP) maintains the common data buffer accessible to all affiliated AP MLDs. The serving AP (AP1) 540 may execute a copy operation, copying buffered data into the SMD data buffer. Subsequently, through appropriate signalling procedures, the identified target AP 560 from the one or more potential target APs (AP2) performs a fetch operation to fetch the data from the SMD data buffer to its local buffer for further handling.

Moreover, a validity timer or the predetermined time period (Ty) may be associated with data copied to the SMD data buffer for efficient resource utilization. Upon timer expiration, SMD automatically clears unutilized buffer contents. Further, the validity timer value determination depends on the following factors: Data type and Access Category; standard Roaming Signalling Completion timing (in worst case scenario); and other SMD and backend system limitations.

FIG. 11 illustrates a schematic diagram 1100 illustrating the distributed data buffer copying mechanism, according to an embodiment of the disclosure.

In an embodiment, upon detecting the trigger for the occurrence of the pre-roaming condition, the serving AP (AP1) 540 initiates buffer copying operations to the data buffer corresponding to each potential target AP (AP2, AP3) within the SMD. The sequence numbers (SN0-SN3) represent the buffered data packets at various stages.

After initiation of the actual roaming to the identified target AP 560 and completion of required signalling procedures, the identified target AP 560, for example, the target AP2, may continue to utilize its buffered data to resume communication with the roamed STA 520.

Further, the potential target AP3 from the one or more potential target APs may maintain the copied buffer data until the expiration of its associated validity timer Tv3. After the expiry of the corresponding validity timer Tv3, the potential target AP3 may delete the buffered data.

Each AP's buffer may implement a standard validity timer (Tv) for efficient resource management. The standard validity timer may be associated with data copied to each target AP's data buffer (e.g. Tv2 for AP2, Tv3 for AP3) so that when left unutilized, the corresponding AP can clear out its data buffer after the corresponding timer expiry.

Values of the validity timers may be determined based on at least one of: Data type and Access Category; standard Roaming Signalling Completion timing (in worst case scenario); and other AP/backend system limitations.

Further, the data buffer copy from the serving AP1 to the target AP2, AP3 may take place at over-the-DS (backend system). Further, copying of the data buffer over-the-DS may be preferred for enterprise deployments. In another embodiment, the data buffer copy from the serving AP1 to the target AP2, AP3 may take place over-the-air (OTA). Further, copying of the data buffer over-the-air may be preferred for residential deployments.

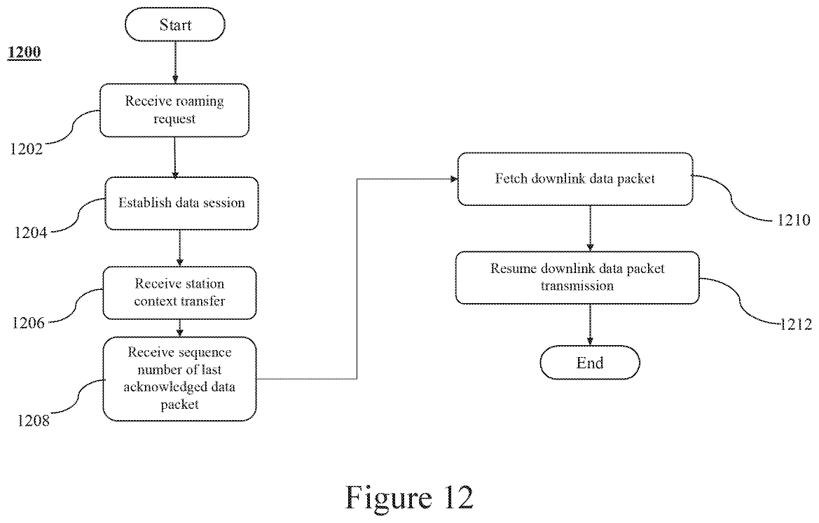

FIG. 12 illustrates an operation 1200 performed by the identified target AP 560, according to an embodiment of the disclosure.

In an embodiment, at operation 1202, the receiving module 656 may be configured to receive the roaming request from the STA 520 based on a baseline protected management frame technique.

At operation 1204, the establishing module 658 may be configured to establish data session context transfer and a distribution system (DS) mapping change with the serving AP 540.

Further, to establish the data session context, the transmitting module 660 may be configured to transmit a station context request to the serving AP 540. The transmitting module 660 may be configured to receive a station context response from the serving AP 540. The transmitting module 660 may be configured to establish the DS mapping change with the serving AP 540. The transmitting module 660 may be configured to transmit a roaming response to the STA 520. The transmitting module 660 may be configured to perform the above mentioned operation when the type of the handover is the panic handover.

At operation 1206, the receiving module 656 may be configured to receive a station context transfer information associated with the STA 520 and an indication of the handover.

At operation 1208, the receiving module 656 may be configured to receive the sequence number of last acknowledged data packet from among the downlink data packet from the serving AP 540, when the type of the handover is the normal handover.

At operation 1210, the fetching module 662 may be configured to fetch a downlink data packet stored in the data buffer by the serving AP 540.

At operation 1212, the resuming module 664 may be configured to resume the downlink data packet transmission with the STA 520 based on the fetching. Herein, resuming module 664 may be configured to resume downlink data packet transmission with the STA 520 containing the fetched downlink data packet with a corresponding sequence number, in a cascading manner.

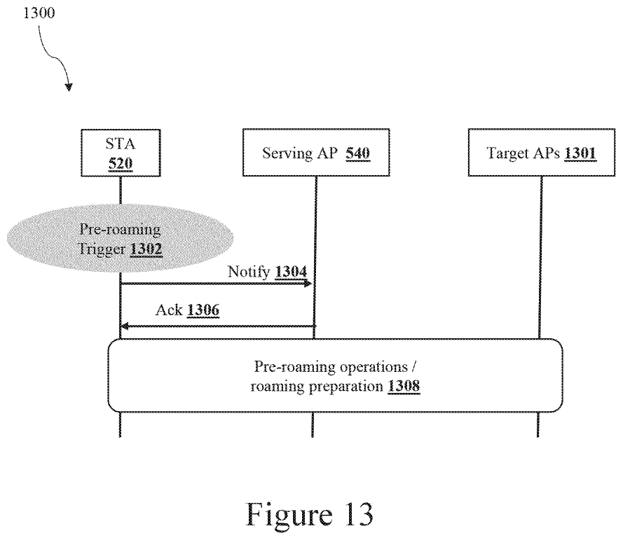

FIG. 13 illustrates a signal flow diagram 1300 providing a pre-roaming trigger evaluation at the station (STA) 520, according to an embodiment of the disclosure.

At operation 1302, the STA 520 may be configured to detect the occurrence of the pre-roaming trigger.

At operation 1304, the STA 520 may be configured to notify the occurrence of the pre-roaming trigger to the serving AP 540.

At operation 1306, the STA 520 may be configured to receive the acknowledgement of the notification from the serving AP 540.

At operation 1308, the STA 520, serving AP 540, the one or more potential target APs 1301 may be configured to performs the set of pre-roaming operations, i.e., storing the downlink data packet in the data buffer for the predetermined time period such that the data buffer is common for each of the serving AP 540 and the one or more potential target APs. Further, storing the downlink data packet in the data buffer corresponding to each of the one or more potential target APs for the predetermined time period.

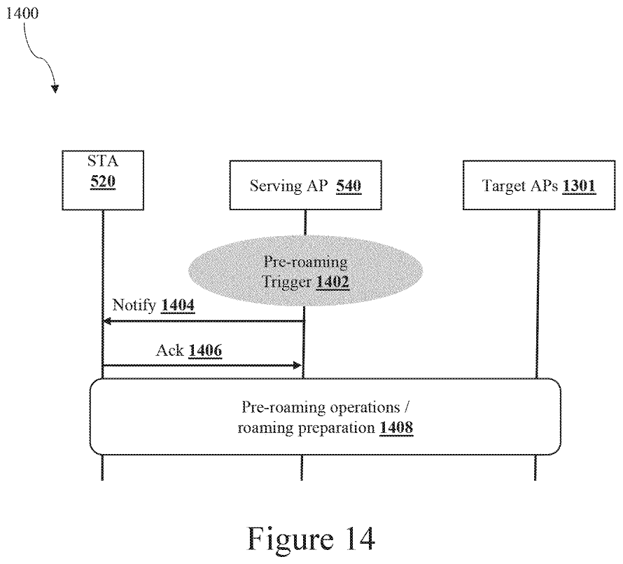

FIG. 14 illustrates a signal flow diagram 1400 providing pre-roaming trigger evaluation at the serving AP 540, according to an embodiment of the disclosure.

At operation 1402, the serving AP 540 may be configured to detect the occurrence of the pre-roaming trigger.

At operation 1404, the serving AP 540 may be configured to notify the occurrence of the pre-roaming trigger to the STA 520.

At operation 1406, the serving AP 540 may be configured to receive the acknowledgement of the notification from the STA 520.

At operation 1408, the STA 520, serving AP 540, the one or more potential target APs 1301 may be configured to performs the set of pre-roaming operations as explained earlier, i.e., storing the downlink data packet in the data buffer for the predetermined time period such that the data buffer is common for each of the serving AP 540 and the one or more potential target APs. Further, storing the downlink data packet in the data buffer corresponding to each of the one or more potential target APs for the predetermined time period.

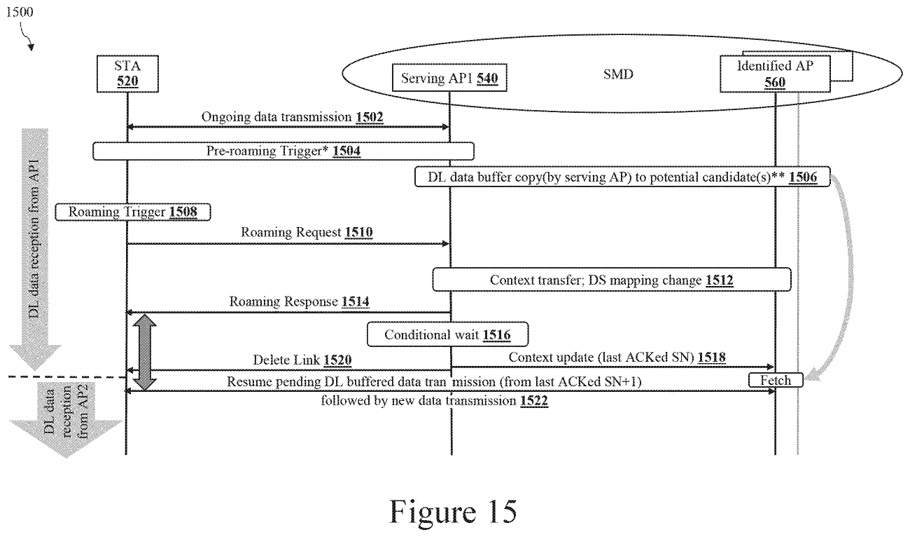

FIG. 15 illustrates a signal flow diagram 1500 indicating buffer handling procedures during normal Received Signal Strength Indicator (RSSI) drop scenarios, i.e. normal handover, according to an embodiment of the disclosure.

In an embodiment, the buffer handling procedures during normal RSSI drop scenarios may initiate with the STA 520 connected to the serving AP 540. Further, the one or more potential target APs may be affiliated to the same SMD.

At operation 1502, the STA 520 may be configured to perform the data transmission with the serving AP 540.

At operation 1504, the STA 520 and the serving AP 540 may be configured to detect the occurrence of the pre-roaming trigger.

At operation 1506, the serving AP 540 may be configured to perform the data buffer copy, i.e., storing the downlink data packet associated with the STA 520 (according to any one of the two options) to one or more potential candidates, i.e., the one or more potential target APs belonging to the same SMD.

At operation 1508, the STA 520 may be configured to detect the occurrence of the roaming condition, i.e., a roaming trigger, subsequently.

At operation 1510, the STA 520 may be configured to transmit the roaming request, including an indication of the identified target AP 560, to the serving AP 540.

At operation 1512, the serving AP 540 and the identified target AP may be engaged in establishing the data session context transfer and the distribution system (DS/backend of AP MLDs) mapping change. Herein, the DS/backend of AP MLDs indicates that the DS acts as the backend of a WLAN router through which downlink (DL) data arrives from the external network. When the STA 520 associates with the AP, a path is established up to the DS (STA 520↔Serving AP 540↔DS), ensuring that DL data destined for the STA 520 is forwarded through the correct AP. When the STA 520 roams from one AP to another, this mapping may be updated at the DS so that subsequent DL data for the STA 520 may be delivered via the new AP (STA↔Identified AP 560↔DS).

At operation 1514, the serving AP 540 may be configured to transmit the roaming response to the STA 520 containing the required information of the identified target AP 560, such as link configuration.

At operation 1516, the serving AP 540 may be configured to transmit the roaming response followed by the conditional wait time period.

At operation 1518, the serving AP 540 may be configured to transmit the sequence number of the last acknowledged data packet from the downlink data packet to the identified target AP 560 as the context update. Herein, the SN may correspond to buffered data being transmitted to the STA 520. Further, at operation 1520, the serving AP 540 may be configured to delete the configured link(s) with the STA 520 upon one of expiration of the conditional wait time period and transmitting the roaming response.

At operation 1522, the identified target AP 560 may be configured to fetch the downlink data packet from the data buffer and further, resume the data transmission with the STA 520 from the last ACKed_SN+1 onwards.

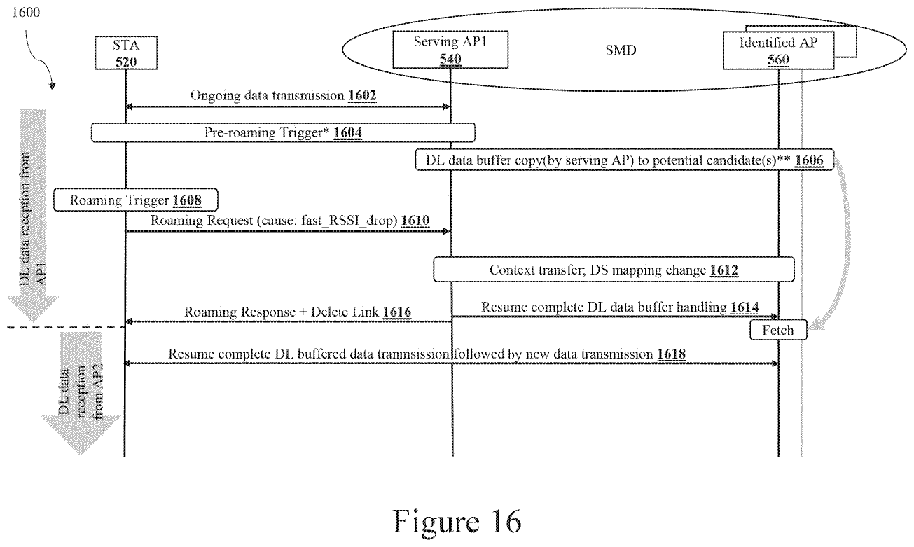

FIG. 16 illustrates a signal flow diagram 1600 indicating buffer handling procedures during fast RSSI drop scenarios, i.e., fast handover, according to an embodiment of the disclosure.

In an embodiment, the buffer handling procedures during the fast RSSI drop scenarios may initiate with the STA 520 connected to the serving AP 540. Further, the one or more potential target APs may be affiliated with the same SMD.

At operation 1602, the STA 520 may be configured to perform the data transmission with the serving AP 540.

At operation 1604, the STA 520 and the serving AP 540 may be configured to detect the occurrence of the pre-roaming trigger.

At operation 1606, the serving AP 540 may be configured to perform the data buffer copy, i.e., storing the downlink data packet associated with the STA 520 (according to any one of the two options) to one or more potential candidates, i.e., the one or more potentials target APs belonging to the same SMD.

At operation 1608, the STA 520 may be configured to detect the occurrence of the roaming condition, i.e., the roaming trigger, subsequently.

At operation 1610, the STA 520 may be configured to transmit the roaming request, including an indication of the identified target AP 560, to the serving AP 540. Herein, the roaming request may indicate cause: fast_RSSI_drop value. Herein, the cause parameter may take different values, one of which is value=fast_RSSI_drop. When this cause value is included, it triggers a specific handling of the roaming sequence and signaling at the serving AP for a fast RSSI drop scenario. This process is clearly distinguishable from the handling used in the normal RSSI drop scenario. Thus, the cause parameter serves as an indication to the serving AP 540 that the connection is likely to be lost quickly, prompting it to follow the appropriate signalling actions to enable a fast handover and minimize data loss.

At operation 1612, the serving AP 540 and the identified target AP 560 may be engaged in establishing the data session context transfer and the distribution system (DS/backend of AP MLDs) mapping change.

At operation 1614, the serving AP 540 may be configured to transmit the request to the identified target AP 560 to resume the complete downlink data packet transmission with the station 520.

At operation 1616, the serving AP 540 may be configured to transmit the roaming response along with the deletion of the configured link(s) with the station 520, to the station 520.

At operation 1618, the identified target AP 560 may be configured to fetch the downlink data packet from the data buffer and further, resume the complete downlink data packet transmission with the station 520, followed by the new data transmissions.

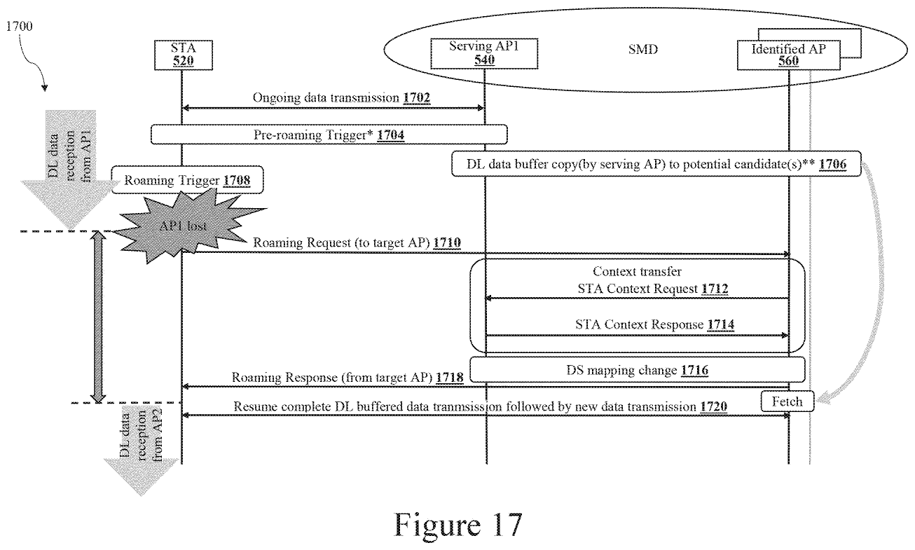

FIG. 17 illustrates a signal flow diagram 1700 indicating buffer handling procedures during panic RSSI drop scenarios, i.e., panic handover, according to an embodiment of the disclosure.

In an embodiment, the buffer handling procedures during normal RSSI drop scenarios may initiate with the STA 520 connected to the serving AP 540. Further, the one or more potential target APs may be affiliated with the same SMD.

At operation 1702, the STA 520 may be configured to perform the data transmission with the serving AP 540.

At operation 1704, the STA 520 and the serving AP 540 may be configured to detect the occurrence of the pre-roaming condition.

At operation 1706, the serving AP 540 may be configured to perform the data buffer copy, i.e., storing the downlink data packet associated with the STA 520 (according to any one of the two options) to one or more potential candidates, i.e., the one or more potential target APs belonging to the same SMD.

At operation 1708, the STA 520 may be configured to detect the occurrence of the roaming condition, i.e., the roaming trigger, subsequently. Herein, the serving AP 540 connection is lost due to rapid degradation in the serving API's RSSI/SINR KPI.

At operation 1710, the STA 520 may be configured to transmit the roaming request to the identified target AP 560. Herein, the STA 520 may be configured to send the roaming request based on the baseline protected management frame technique. The STA 520 may try to re-establish the connection with the identified target AP 560. Further, the STA 520 may also include the serving AP 540 information and association identifier of the STA 520 with the serving AP 540 so that the identified target AP 560 may fetch essential context from a previous serving AP.

In an embodiment, the Roaming Request message format may incorporate a plurality of essential parameters, but not limited to, required for seamless roaming procedure implementation as shown below:

```
  Roaming Request
  {
      ...
      target AP ID;
      //AP identifier for the target AP to which STA
prefers to roam to after roaming trigger is hit
      cause(enum);
      //optional to include cause value in all cases but for
fast KPI drop, mandatory to include along with cause value enum such as:
  fast_RSSI_drop;
  fast_SINR_drop;
    ...
      serving AP ID;
      //this element shall only be included for panic drop
cases (when Roaming Request is directly sent to target AP from STA) in order to inform
target AP about the ‘previous serving AP’ to help target AP fetch the lost context about
STA from the previous serving AP
      AID;
      //the association ID of the STA (with serving AP)
shall only be included if ‘serving AP ID’ is included, so that target AP can request for
context information about this associated STA to the previous serving AP
      ...
      //rest TBD
  }
```

At operation 1712, the identified target AP 560 may be configured to send the STA context request to the serving AP 540. Herein, the serving AP 540 may be the previous serving AP. The STA context request may include a previous Association ID of the STA 520.

At operation 1714, the identified target AP 560 may be configured to receive the STA context response from the serving AP 540. The STA context response may include the data context of the STA 520. Herein, the STA response may include data session context, for example, Sequence Number (SN), Packet Number information per Traffic Identifier, Block Acknowledgment statistics of the STA 520.

At operation 1716, the serving AP 540 and the identified target AP 560 may be engaged to establish the Distributed System (DS/backend of AP MLDs) mapping changes.

At operation 1718, the target AP2 may be configured to transmit the roaming response to the STA 520.

At operation 1720, the identified target AP 560 may be configured to fetch the downlink data packet from the data buffer and further resume the complete downlink data packet transmission with the station 520, followed by the new data transmissions.

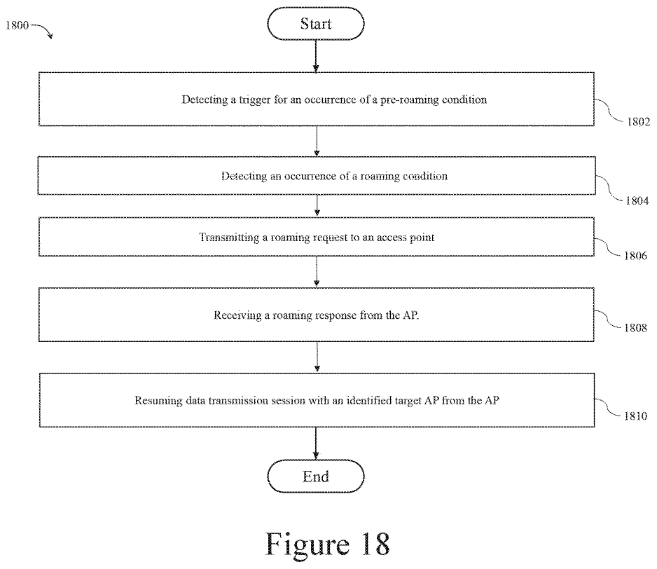

FIG. 18 illustrates a flowchart of a method performed by the STA, according to an embodiment of the disclosure.

The method 1800 includes a series of operations shown at operation 1802 through operation 1810 of FIG. 18. The method 1800 may be performed by the system 610 through modules 606, the details of which are explained with reference to FIGS. 6A, 7 and 8, and the same are not repeated here for the sake of brevity of the disclosure. The method 1800 begins at operation 1802.

At operation 1802, the method 1800 may include detecting the trigger for the occurrence of the pre-roaming condition.

Prior to detecting the trigger for the occurrence of the pre-roaming condition, the method 1800 may include performing data transmission with the serving AP 540 from the AP.

Further, for detecting the trigger, the method 1800 may include monitoring the value of the Key Performance Indicator (KPI) of the serving AP 540. The KPI indicates Received Signal Strength Indicator (RSSI) or Signal-to-Interference & Noise Ratio (SINR) observed between the serving AP 540 and the station 520.

The method 1800 may include comparing the value with the predetermined threshold value.

The method 1800 may include detecting the trigger for the occurrence of the pre-roaming condition, when the value of the KPI is equal to or less than the predetermined threshold value.

Upon detecting the trigger, the method 1800 may include notifying the detected trigger to the serving AP 540. Further, the method 1800 may include receiving the acknowledgement of the notification from the serving AP 540.

At operation 1804, the method 1800 may include detecting the occurrence of the roaming condition.

At operation 1806, the method 1800 may include transmitting the roaming request to the AP. The roaming request may include at least the target AP identifier (APID) field, the cause field identifying the type of handover, the serving APID field and the association identifier (AID) field. Herein, the type of handover may indicate one of the normal handover, the fast handover, and the panic handover.

Herein, the method 1800 may include transmitting the roaming request to the serving AP 540, when the type of the handover indicates one of the normal handover and the fast handover. Further, the method 1800 may include transmitting the roaming request to the identified target AP 560, when the type of the handover indicates the panic handover.

The roaming request may indicate cause: fast_RSSI_drop value, when the type of handover indicates the fast handover.

At operation 1808, the method 1800 may include receiving the roaming response from the AP.

Herein, the method 1800 may include receiving the roaming response from the serving AP 540, when the type of the handover indicates one of the normal handover and the fast handover. Further, the method 1800 may include receiving the roaming response from the identified target AP 560, when the type of the handover indicates panic handover.

The roaming response may include the link(s) configuration with the identified target AP 560 after the context transfer and backend distribution system (DS) path update between the serving AP 540 and the identified target AP 560. Further, the roaming response may be followed by the conditional wait time period, when the type of the handover may be the normal handover.

The method 1800 may include detecting the connection closure condition from the serving AP 540 from the AP upon one of expiration of the conditional wait time period, followed by resumption of the data transmission with the identified target AP 560.

At operation 1810, the method 1800 may include resuming the data transmission session with the identified target AP 560 from the AP.

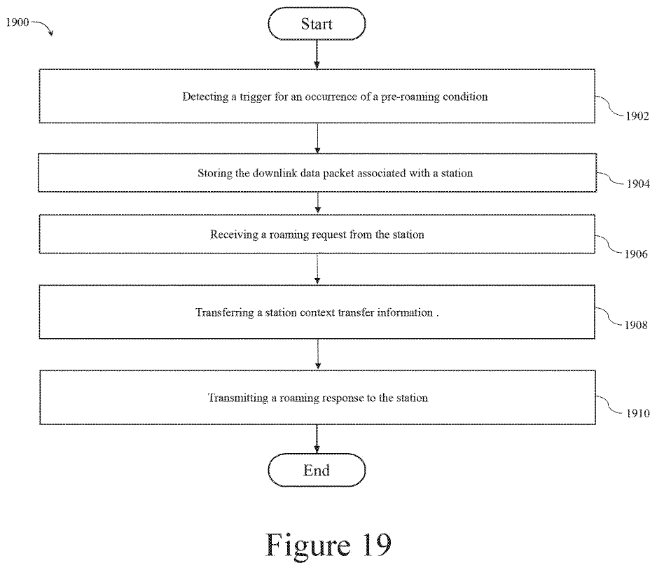

FIG. 19 illustrates a flowchart of a method performed by the serving AP, according to an embodiment of the disclosure.

The method 1900 includes a series of operations shown at operation 1902 through operation 1910 of FIG. 19. The method 1900 may be performed by the system 623 through modules 628, the details of which are explained with reference to FIGS. 6A, 9, 10 and 11, and the same are not repeated here for the sake of brevity of the disclosure. The method 1900 begins at operation 1902.

At operation 1902, the method 1900 may include detecting the trigger for the occurrence of the pre-roaming condition.

Prior to detecting the trigger for the occurrence of the pre-roaming condition, the method 1900 may include performing data transmission with the station 520.

For detecting the trigger, the method 1900 may include monitoring the value of the Key Performance Indicator (KPI). The KPI may indicate RSSI or SINR observed between the serving AP 540 and the station 520. The method 1900 may include comparing the value with the predetermined threshold value. Further, the method 1900 may include detecting the trigger for the occurrence of the pre-roaming condition, when the value of the KPI is equal to or less than the predetermined threshold value.

Upon detecting the trigger, the method 1900 may include notifying the detected trigger to the station 520. Further, the method 1900 may include receiving the acknowledgement of the notification from the station 520.

At operation 1904, the method 1900 may include storing the downlink data packet associated with the station 520, in the data buffer associated to the one or more potential target APs such that the downlink data packet forwarded in the data buffer.

The method 1900 may include storing the downlink data packet in the data buffer for the predetermined time period such that the data buffer may be common for each of the serving AP 540 and the one or more potential target APs. The data buffer along with the serving AP 540 and the one or more potential target APs forms part of the common Seamless Mobility Domain (SMD).

Further, the method 1900 may include deleting the forwarded downlink data packet from the data buffer after expiry of the predetermined time period.

The method 1900 may include storing the downlink data packet in the data buffer corresponding to each of the one or more potential target APs for the predetermined time period. The data buffer along with the serving AP 540 and the one or more potential target APs forms part of the common Seamless Mobility Domain (SMD).

The type of handover may indicate the normal handover, the fast handover, and the panic handover.

At operation 1906, the method 1900 may include receiving the roaming request from the station 520. The roaming request identifies the type of handover. The roaming request identifies at least the target AP identifier (APID) field, the cause field identifying the type of handover, the serving APID field and the association identifier (AID) field.

The method 1900 may include receiving the roaming request from the station 520, when the type of the handover indicates one of the normal handover and the fast handover.

The roaming request may indicate cause: fast_RSSI_drop value, when the type of handover indicates the fast handover.

At operation 1908, the method 1900 may include transferring the station context transfer information associated with the station 520 to the identified target AP 560 from the one or more potential target APs based on establishing data session context transfer with the identified target AP 560.

At operation 1910, the method 1900 may include transmitting the roaming response to the station 520.

The method 1900 may include transmitting the roaming response to the station 520, when the type of the handover indicates one of the normal handover, and the fast handover. The roaming response may indicate the link(s) configuration with the identified target AP 560 after the context transfer and backend distribution system (DS) path update between the serving AP 540 and the identified target AP 560.

Further, for transmitting the roaming response, the method 1900 may include transmitting the roaming response along with the deletion of the configured link(s) with the station 520, when the type of handover is the fast handover.

Further, the method 1900 may include transmitting the roaming response followed by the conditional wait time period, when the type of handover is the normal handover.

Upon transmitting the roaming response followed by the conditional wait timer, the method 1900 may include upon expiry of the conditional wait time period, transmitting the sequence number of last acknowledged data packet from the downlink data packet to the identified target AP 560. Further, the method 1900 may include deleting the configured link(s) with the station 520 upon one of expiration of the conditional wait time period, and transmitting the roaming response.

The method 1900 may include transmitting the request to the identified target AP 560 to resume the complete downlink data packet transmission with the station 520.

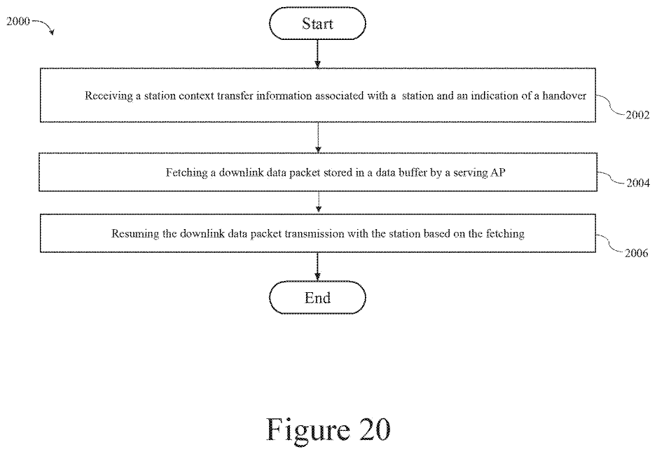

FIG. 20 illustrates a flowchart of a method performed by the identified AP, according to an embodiment of the disclosure.

The method 2000 includes a series of operations shown at operation 2002 through operation 2006 of FIG. 20. The method 2000 may be performed by the system 646 through modules 652, the details of which are explained with reference to FIGS. 6B and 12, and the same are not repeated here for the sake of brevity of the disclosure. The method 2000 begins at operation 2002.

At operation 2002, the method 2000 may include receiving the station context transfer information associated with the station 520 and the indication of the handover.

Prior to receiving the station context transfer information, the method 2000 may include receiving the roaming request from the station 520 based on the baseline protected management frame technique. Further, the method 2000 may include establishing data session context transfer and the distribution system (DS) mapping change with the serving AP 540.

For establishing data session, when the type of the handover is the panic handover, the method 2000 may include transmitting the station context request to the serving AP 540. The method 2000 may include receiving the station context response from the serving AP 540. The method 2000 may include establishing DS mapping change with the serving AP 540. Further, the method 2000 may include transmitting the roaming response to the station 520.

Upon receiving the station context transfer information and the indication of the handover, the method 2000 may include receiving the sequence number of last acknowledged data packet from among the downlink data packet from the serving AP 540, when the type of the handover is the normal handover. Further, the method includes resuming downlink data packet transmission with the station containing fetched downlink data packet with the corresponding sequence number, in the cascading manner.

At operation 2004, the method 2000 may include fetching the downlink data packet stored in the data buffer by the serving AP 540.

At operation 2006, the method 2000 may include resuming the downlink data packet transmission with the station 520 based on the fetching.

One aspect of the present disclosure provides a method 1800 performed by a station 520 in a wireless network. The method comprises detecting, by the station 520, a trigger for an occurrence of a pre-roaming condition. The method comprises detecting, by the station 520, an occurrence of a roaming condition. The method comprises transmitting, by the station 520, a roaming request to a serving access point (AP). The roaming request comprises at least one of a target access point (AP) identifier (APID) field, a cause field identifying a type of handover, a serving APID field, or an association identifier (AID) field. The roaming request may comprise a target access point (AP) identifier (APID) field, a cause field identifying a type of handover, a serving APID field, and an association identifier (AID) field. The method comprises receiving (1808), by the station 520, a roaming response from the serving AP 540. The method comprises resuming, by the station 520, data transmission session with an identified target AP 560.

In an embodiment, the method 1800 comprises, prior to the detecting of the trigger for the occurrence of the pre-roaming condition, performing data transmission with a serving AP 540.

In an embodiment, the detecting of the trigger comprises detecting the trigger for the occurrence of the pre-roaming condition based on a key performance indicator (KPI) of the serving AP 540.

In an embodiment, the detecting of the trigger comprises: monitoring a value of a key performance indicator (KPI) of a serving AP 540, wherein the KPI includes at least one of received signal strength indicator (RSSI) or signal-to-interference & noise ratio (SINR) observed between the serving AP and the station; comparing the value with a predetermined threshold value; and detecting the trigger for the occurrence of the pre-roaming condition, when the value of the KPI is equal to or less than the predetermined threshold value.

In an embodiment, the method 1800 comprises, upon the detecting of the trigger, notifying the detected trigger to a serving AP 540, and receiving an acknowledgement of the notification from the serving AP 540.

In an embodiment, the type of handover indicates one of a normal handover, a fast handover, or a panic handover.

In an embodiment, the transmitting of the roaming request comprises: transmitting the roaming request to a serving AP 540, when the type of the handover indicates one of a normal handover and a fast handover; and transmitting the roaming request to the target AP 560, when the type of the handover indicates a panic handover.

In an embodiment, the receiving of the roaming response comprises: receiving the roaming response from a serving AP 540, when the type of the handover indicates one of a normal handover and a fast handover; receiving the roaming response from the target AP 560, when the type of the handover indicates panic handover. The roaming response comprises a link configuration with the target AP after a context transfer and backend distribution system (DS) path update between the serving AP and the target AP. The roaming response is followed by a conditional wait time period, when the type of handover is a normal handover.

In an embodiment, the method 1800 comprises detecting a connection closure condition from a serving AP 540 upon one of expiration of a conditional wait time period, followed by resumption of data transmission with the target AP 560.

In an embodiment, the roaming request indicates cause “fast_RSSI_drop value” when the type of handover indicates a fast handover.

One aspect of the present disclosure provides a method (1900) performed by a serving access point (AP) 540 in a wireless network. The method comprises detecting, by the serving AP 540, a trigger for an occurrence of a pre-roaming condition. The method comprises storing, by the serving AP 540, downlink data packet associated with a station 520, in a data buffer associated to one or more potential target APs such that the downlink data packet may be forwarded from the data buffer. The method comprises receiving, by the serving AP 540, a roaming request from the station 520. The roaming request identifies a type of handover. The roaming request comprises at least one of a target AP identifier (APID) field, a cause field identifying the type of handover, a serving APID field, or an association identifier (AID) field. The roaming request may comprise a target AP identifier (APID) field, a cause field identifying the type of handover, a serving APID field, and an association identifier (AID) field. The method comprises transferring, by the serving AP 540, a station context transfer information associated with the station 520 to an identified target AP 560 from the one or more potential target APs based on establishing data session context transfer with the identified target AP 560. The method comprises transmitting, by the serving AP 540, a roaming response to the station 520.

In an embodiment, the method 1900 comprises, prior to the detecting of the trigger for the occurrence of the pre-roaming condition, performing data transmission with the station 520.

In an embodiment, the method 1900 comprises detecting the trigger for the occurrence of the pre-roaming condition based on a key performance indicator (KPI) of the serving AP 540.

In an embodiment, the detecting of the trigger comprises: monitoring a value of a key performance indicator (KPI), wherein the KPI comprises at least one of RSSI or SINR observed between the serving AP 540 and the station 520; comparing the value with a predetermined threshold value; and detecting the trigger for the occurrence of the pre-roaming condition, when the value of the KPI is equal to or less than the predetermined threshold value.

In an embodiment, the method 1900 comprises, upon the detecting of the trigger, notifying the detected trigger to the station 520, and receiving an acknowledgement of the notification from the station 520.

In an embodiment, the storing of the downlink data packet associated with the station comprises: storing the downlink data packet in a data buffer for a predetermined time period such that the data buffer is common for each of the serving AP 540 and the one or more potential target APs, wherein the data buffer along with the serving AP 540 and the one or more potential target APs forms part of a common seamless mobility domain (SMD).

In an embodiment, the method 1900 comprises deleting the downlink data packet from the data buffer after expiry of a predetermined time period.

In an embodiment, the storing of the downlink data packet associated with the station 520 comprises storing the downlink data packet in a data buffer corresponding to each of the one or more potential target APs for a predetermined time period, wherein the data buffer along with the serving AP 520 and the one or more potential target APs forms part of a common seamless mobility domain (SMD).

In an embodiment, the type of handover indicates one of a normal handover, a fast handover, or a panic handover.

In an embodiment, the receiving of the roaming request comprises receiving the roaming request from the station 520, when the type of the handover indicates one of a normal handover and a fast handover.

In an embodiment, the transmitting of the roaming response comprises transmitting the roaming response to the station 520, when the type of the handover indicates one of a normal handover, and a fast handover, wherein the roaming response indicates a link configuration with the identified target AP 560 after a context transfer and backend distribution system (DS) path update between the serving AP and the identified target AP 560.

In an embodiment, the transmitting of the roaming response comprises transmitting the roaming response followed by a conditional wait time period, when the type of handover is a normal handover.

In an embodiment, the method 1900 comprises, upon the transmitting of the roaming response followed by the conditional wait time period, upon expiry of the conditional wait time period, transmitting a sequence number of last acknowledged data packet from the downlink data packet to the identified target AP 560, and deleting a configured link with the station upon one of expiration of a conditional wait time period, and transmitting the roaming response.

In an embodiment, the roaming request indicates cause “fast_RSSI_drop value” when the type of handover indicates a fast handover.

In an embodiment, the method comprises transmitting a request to the identified target AP to resume a complete downlink data packet transmission with the station 520.

In an embodiment, the transmitting of the roaming response comprises transmitting the roaming response along with a deletion of a configured link with the station, when the type of handover is a fast handover.

One aspect of the present disclosure provides a method (2000) performed by a target access point (AP) 560 in a wireless network. The method comprises receiving, by the target AP 560, a station context transfer information associated with a station 520 and an indication of a handover. The method comprises fetching, by the target AP 560, a downlink data packet stored in a data buffer by a serving AP 540. The method comprises resuming, by the target AP 560, a downlink data packet transmission with the station 520 based on the fetching.

In an embodiment, the method 2000 comprises, prior to receiving the station context transfer information, receiving a roaming request from the station 520 based on a baseline protected management frame technique. The method comprises establishing data session context transfer and a distribution system (DS) mapping change with a serving AP 540.

In an embodiment, the establishing of the data session context, when a type of the handover is a panic handover, comprises: transmitting a station context request to the serving AP 540; receiving a station context response from the serving AP 540; establishing DS mapping change with the serving AP 540; and transmitting a roaming response to the station 520.

In an embodiment, the method comprises, upon the receiving of the station context transfer information and the indication of the handover, receiving a sequence number of last acknowledged data packet from among the downlink data packet from the serving AP 540, when a type of the handover is a normal handover; and resuming downlink data packet transmission with the station 520 containing fetched downlink data packet with a corresponding sequence number, in a cascading manner.

One aspect of the present disclosure provides a station (STA). The station 520 comprises at least one processor 602 including processing circuitry. The station 520 comprises memory 604 storing instructions that, when executed by the at least one processor 602 individually or collectively, cause the station 520 to detect a trigger for an occurrence of a pre-roaming condition. The instructions, when executed by the at least one processor 602 individually or collectively, cause the station 520 to detect an occurrence of a roaming condition. The instructions, when executed by the at least one processor 602 individually or collectively, cause the station 520 to transmit a roaming request to a serving access point (AP). The roaming request comprises at least one of a target access point (AP) identifier (APID) field, a cause field identifying a type of handover, a serving APID field, or an association identifier (AID) field. The roaming request may comprise a target access point (AP) identifier (APID) field, a cause field identifying a type of handover, a serving APID field, and an association identifier (AID) field. The instructions, when executed by the at least one processor 602 individually or collectively, cause the station 520 to receive a roaming response from the serving AP 540. The instructions, when executed by the at least one processor 602 individually or collectively, cause the station 520 to resume data transmission session with an identified target AP 560.

In an embodiment, the instructions, when executed by the at least one processor 602 individually or collectively, cause the station 520 to perform data transmission with a serving AP 540, prior to the detecting of the trigger for the occurrence of the pre-roaming condition.

In an embodiment, to detect the trigger, the instructions, when executed by the at least one processor 602 individually or collectively, cause the station 520 to detect the trigger for the occurrence of the pre-roaming condition based on a key performance indicator (KPI) of the serving AP 540.

In an embodiment, to detect the trigger, the instructions, when executed by the at least one processor 602 individually or collectively, cause the station 520 to monitor a value of a key performance indicator (KPI) of a serving AP 540, wherein the KPI includes at least one of received signal strength indicator (RSSI) or signal-to-interference & noise ratio (SINR) observed between the serving AP and the station; compare the value with a predetermined threshold value; and detect the trigger for the occurrence of the pre-roaming condition, when the value of the KPI is equal to or less than the predetermined threshold value.

In an embodiment, the instructions, when executed by the at least one processor 602 individually or collectively, cause the station 520 to, upon the detecting of the trigger, notify the detected trigger to a serving AP 540, and receive an acknowledgement of the notification from the serving AP 540.

In an embodiment, the type of handover indicates one of a normal handover, a fast handover, or a panic handover.

In an embodiment, to transmit the roaming request, the instructions, when executed by the at least one processor 602 individually or collectively, cause the station 520 to transmit the roaming request to a serving AP 540, when the type of the handover indicates one of a normal handover and a fast handover; and transmitting the roaming request to the target AP 560, when the type of the handover indicates a panic handover.

In an embodiment, to receive the roaming response, the instructions, when executed by the at least one processor 602 individually or collectively, cause the station 520 to receive the roaming response from a serving AP 540, when the type of the handover indicates one of a normal handover and a fast handover; receive the roaming response from the target AP 560, when the type of the handover indicates panic handover. The roaming response comprises a link configuration with the target AP after a context transfer and backend distribution system (DS) path update between the serving AP and the target AP. The roaming response is followed by a conditional wait time period, when the type of handover is a normal handover.

In an embodiment, the instructions, when executed by the at least one processor 602 individually or collectively, cause the station 520 to detect a connection closure condition from a serving AP 540 upon one of expiration of a conditional wait time period, followed by resumption of data transmission with the target AP 560.

In an embodiment, the roaming request indicates cause “fast_RSSI_drop value” when the type of handover indicates a fast handover.

One aspect of the present disclosure provides a serving access point (AP) 540. The serving AP 540 comprises at least one processor 624 including processing circuitry. The serving AP 540 comprises memory 626 storing instructions that, when executed by the at least one processor 624 individually or collectively, cause the serving AP 540 to detect a trigger for an occurrence of a pre-roaming condition. The instructions, when executed by the at least one processor 624 individually or collectively, cause the serving AP 540 to store downlink data packet associated with a station 520, in a data buffer associated to one or more potential target APs such that the downlink data packet may be forwarded from the data buffer. The instructions, when executed by the at least one processor 624 individually or collectively, cause the serving AP 540 to receive a roaming request from the station 520. The roaming request identifies a type of handover. The roaming request comprises at least one of a target AP identifier (APID) field, a cause field identifying the type of handover, a serving APID field, or an association identifier (AID) field. The roaming request may comprise a target AP identifier (APID) field, a cause field identifying the type of handover, a serving APID field, and an association identifier (AID) field. The method comprises transferring, by the serving AP 540, a station context transfer information associated with the station 520 to an identified target AP 560 from the one or more potential target APs based on establishing data session context transfer with the identified target AP 560. The instructions, when executed by the at least one processor 624 individually or collectively, cause the serving AP 540 to transmit a roaming response to the station 520.

In an embodiment, the instructions, when executed by the at least one processor 624 individually or collectively, cause the serving AP 540 to, prior to the detecting of the trigger for the occurrence of the pre-roaming condition, perform data transmission with the station 520.

In an embodiment, the instructions, when executed by the at least one processor 624 individually or collectively, cause the serving AP 540 to detect the trigger for the occurrence of the pre-roaming condition based on a key performance indicator (KPI) of the serving AP 540.

In an embodiment, to detect the trigger, the instructions, when executed by the at least one processor 624 individually or collectively, cause the serving AP 540 to monitor a value of a key performance indicator (KPI), wherein the KPI comprises at least one of RSSI or SINR observed between the serving AP 540 and the station 520; compare the value with a predetermined threshold value; and detect the trigger for the occurrence of the pre-roaming condition, when the value of the KPI is equal to or less than the predetermined threshold value.

In an embodiment, the instructions, when executed by the at least one processor 624 individually or collectively, cause the serving AP 540 to, upon the detecting of the trigger, notify the detected trigger to the station 520, and receive an acknowledgement of the notification from the station 520.

In an embodiment, to store the downlink data packet associated with the station, instructions, when executed by the at least one processor 624 individually or collectively, cause the serving AP 540 to store the downlink data packet in a data buffer for a predetermined time period such that the data buffer is common for each of the serving AP 540 and the one or more potential target APs, wherein the data buffer along with the serving AP 540 and the one or more potential target APs forms part of a common seamless mobility domain (SMD).

In an embodiment, the instructions, when executed by the at least one processor 624 individually or collectively, cause the serving AP 540 to delete the downlink data packet from the data buffer after expiry of a predetermined time period.

In an embodiment, to store the downlink data packet associated with the station 520, instructions, when executed by the at least one processor 624 individually or collectively, cause the serving AP 540 to store the downlink data packet in a data buffer corresponding to each of the one or more potential target APs for a predetermined time period, wherein the data buffer along with the serving AP 520 and the one or more potential target APs forms part of a common seamless mobility domain (SMD).

In an embodiment, the type of handover indicates one of a normal handover, a fast handover, or a panic handover.

In an embodiment, to receive the roaming request, instructions, when executed by the at least one processor 624 individually or collectively, cause the serving AP 540 to receive the roaming request from the station 520, when the type of the handover indicates one of a normal handover and a fast handover.

In an embodiment, to transmit the roaming response, instructions, when executed by the at least one processor 624 individually or collectively, cause the serving AP 540 to transmit the roaming response to the station 520, when the type of the handover indicates one of a normal handover, and a fast handover, wherein the roaming response indicates a link configuration with the identified target AP 560 after a context transfer and backend distribution system (DS) path update between the serving AP and the identified target AP 560.

In an embodiment, to transmit the roaming response, instructions, when executed by the at least one processor 624 individually or collectively, cause the serving AP 540 to transmit the roaming response followed by a conditional wait time period, when the type of handover is a normal handover.

In an embodiment, the instructions, when executed by the at least one processor 624 individually or collectively, cause the serving AP 540 to, upon the transmitting of the roaming response followed by the conditional wait time period, upon expiry of the conditional wait time period, transmit a sequence number of last acknowledged data packet from the downlink data packet to the identified target AP 560, and delete a configured link with the station upon one of expiration of a conditional wait time period, and transmit the roaming response.

In an embodiment, the roaming request indicates cause “fast_RSSI_drop value” when the type of handover indicates a fast handover.

In an embodiment, the instructions, when executed by the at least one processor 624 individually or collectively, cause the serving AP 540 to transmit a request to the identified target AP to resume a complete downlink data packet transmission with the station 520.

In an embodiment, to transmit the roaming response, instructions, when executed by the at least one processor 624 individually or collectively, cause the serving AP 540 to transmit the roaming response along with a deletion of a configured link with the station, when the type of handover is a fast handover.

One aspect of the present disclosure provides a target access point (AP) 560. The target AP 560 comprises at least one processor 648 including processing circuitry. The target AP 560 comprises memory 650 storing instructions that, when executed by the at least one processor 648 individually or collectively, cause the target AP 560 to receive a station context transfer information associated with a station 520 and an indication of a handover. The instructions, when executed by the at least one processor 648 individually or collectively, cause the target AP 560 to fetch a downlink data packet stored in a data buffer by a serving AP 540. The instructions that, when executed by the at least one processor 648 individually or collectively, cause the target AP 560 to resume a downlink data packet transmission with the station 520 based on the fetching.

In an embodiment, the instructions, when executed by the at least one processor 648 individually or collectively, cause the target AP 560 to, prior to receiving the station context transfer information, receive a roaming request from the station 520 based on a baseline protected management frame technique. The instructions, when executed by the at least one processor 648 individually or collectively, cause the target AP 560 to establish data session context transfer and a distribution system (DS) mapping change with a serving AP 540.

In an embodiment, to establish the data session context, when a type of the handover is a panic handover, the instructions, when executed by the at least one processor 648 individually or collectively, cause the target AP 560 to transmit a station context request to the serving AP 540; receive a station context response from the serving AP 540; establish DS mapping change with the serving AP 540; and transmit a roaming response to the station 520.

In an embodiment, the instructions, when executed by the at least one processor 648 individually or collectively, cause the target AP 560 to, upon the receiving of the station context transfer information and the indication of the handover, receive a sequence number of last acknowledged data packet from among the downlink data packet from the serving AP 540, when a type of the handover is a normal handover; and resume downlink data packet transmission with the station 520 containing fetched downlink data packet with a corresponding sequence number, in a cascading manner.

One aspect of the present disclosure provides a non-transitory computer-readable storage medium. The methods disclosed herein can be performed by one or more computer programs stored on the non-transitory computer-readable storage.

One aspect of the present disclosure provides a non-statutory computer-readable storage medium storing one or more computer programs comprising instructions to perform a method performed by a station (STA) 520 in a wireless network. The method comprises detecting, by the station 520, a trigger for an occurrence of a pre-roaming condition. The method comprises detecting, by the station 520, an occurrence of a roaming condition. The method comprises transmitting, by the station 520, a roaming request to a serving access point (AP). The roaming request comprises at least one of a target access point (AP) identifier (APID) field, a cause field identifying a type of handover, a serving APID field, or an association identifier (AID) field. The roaming request may comprise a target access point (AP) identifier (APID) field, a cause field identifying a type of handover, a serving APID field, and an association identifier (AID) field. The method comprises receiving (1808), by the station 520, a roaming response from the serving AP 540. The method comprises resuming, by the station 520, data transmission session with an identified target AP 560.

One aspect of the present disclosure provides a non-statutory computer-readable storage medium storing one or more computer programs comprising instructions to perform a method performed by a serving access point (AP) 540 in a wireless network. The method comprises detecting, by the serving AP 540, a trigger for an occurrence of a pre-roaming condition. The method comprises storing, by the serving AP 540, downlink data packet associated with a station 520, in a data buffer associated to one or more potential target APs such that the downlink data packet may be forwarded from the data buffer. The method comprises receiving, by the serving AP 540, a roaming request from the station 520. The roaming request identifies a type of handover. The roaming request comprises at least one of a target AP identifier (APID) field, a cause field identifying the type of handover, a serving APID field, or an association identifier (AID) field. The roaming request may comprise a target AP identifier (APID) field, a cause field identifying the type of handover, a serving APID field, and an association identifier (AID) field. The method comprises transferring, by the serving AP 540, a station context transfer information associated with the station 520 to an identified target AP 560 from the one or more potential target APs based on establishing data session context transfer with the identified target AP 560. The method comprises transmitting, by the serving AP 540, a roaming response to the station 520.

One aspect of the present disclosure provides a non-statutory computer-readable storage medium storing one or more computer programs comprising instructions to perform a method performed by a target access point (AP) 560 in a wireless network. The method comprises receiving, by the target AP 560, a station context transfer information associated with a station 520 and an indication of a handover. The method comprises fetching, by the target AP 560, a downlink data packet stored in a data buffer by a serving AP 540. The method comprises resuming, by the target AP 560, a downlink data packet transmission with the station 520 based on the fetching.

The disclosure ensures seamless roaming in wireless networks by introducing mechanisms that significantly reduce data loss and service interruption during handovers. It achieves this through the pre-roaming trigger conditions that proactively prepares for roaming events, enabling faster signalling and context transfer even under rapid signal degradation. Additionally, the disclosure provides innovative downlink data buffer handling techniques, such as copying data packets to the common data buffer or individual target AP data buffer, which allows the identified target AP to resume data transmission from the last acknowledged sequence number onwards. These features collectively deliver near-lossless handovers, maintain application performance for real-time and non-real-time services, minimize TCP congestion issues, thereby improving overall user experience and network reliability.

Further, the disclosure also helps in identifying the need for initiating faster pre-roaming operations before the connection to the serving AP is actually lost. It enables proactive pre-roaming actions to manage buffered downlink data at the serving AP, thereby minimizing or avoiding data loss and supporting lossless handover. The mechanism is applicable to all signal degradation scenarios, including sudden or panic drops such as those experienced in elevators or tunnels. Additionally, it facilitates quicker context transfer and data-path switching between the serving and target APs, helping to meet Wi-Fi 8 requirements for seamless roaming.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a station for managing seamless roaming in a wireless network, the method comprising:
detecting, by the station, a trigger for an occurrence of a pre-roaming condition;
detecting, by the station, an occurrence of a roaming condition;
transmitting, by the station, a roaming request to a serving access point (AP), wherein the roaming request comprises at least a target access point (AP) identifier (APID) field, a cause field identifying a type of handover, a serving APID field, and an association identifier (AID) field;
receiving, by the station, a roaming response from the serving AP; and
resuming, by the station, data transmission session with a target AP.

2. The method of claim 1, further comprising, prior to the detecting of the trigger for the occurrence of the pre-roaming condition, performing data transmission with a serving AP.

3. The method of claim 1, wherein the detecting of the trigger comprises:
monitoring a value of a key performance indicator (KPI) of a serving AP, wherein the KPI comprises at least one of received signal strength indicator (RSSI) or signal-to-interference & noise ratio (SINR) observed between the serving AP and the station;
comparing the value with a predetermined threshold value; and
detecting the trigger for the occurrence of the pre-roaming condition, when the value of the KPI is equal to or less than the predetermined threshold value.

4. The method of claim 1, further comprising:
upon the detecting of the trigger:
notifying the detected trigger to a serving AP; and
receiving an acknowledgement of the notification from the serving AP.

5. The method of claim 1, wherein the type of handover indicates one of a normal handover, a fast handover, or a panic handover.

6. The method of claim 1, wherein the transmitting of the roaming request comprises:
transmitting the roaming request to a serving AP, when the type of the handover indicates one of a normal handover and a fast handover; and
transmitting the roaming request to the target AP, when the type of the handover indicates a panic handover.

7. The method of claim 1,
wherein the receiving of the roaming response comprises:
receiving the roaming response from a serving AP, when the type of the handover indicates one of a normal handover and a fast handover; and
receiving the roaming response from the target AP, when the type of the handover indicates panic handover,
wherein the roaming response comprises a link configuration with the target AP after a context transfer and backend distribution system (DS) path update between the serving AP and the target AP and
wherein the roaming response is followed by a conditional wait time period, when the type of handover is a normal handover.

8. The method of claim 1, further comprising:
detecting a connection closure condition from a serving AP upon one of expiration of a conditional wait time period, followed by resumption of data transmission with the target AP.

9. The method of claim 1, wherein the roaming request indicates cause “fast_RSSI_drop value” when the type of handover indicates a fast handover.

10. A method performed by a serving access point (AP) for managing seamless roaming in a wireless network, the method comprising:
detecting, by the serving AP, a trigger for an occurrence of a pre-roaming condition;
storing, by the serving AP, downlink data packet associated with a station, in a data buffer associated to one or more potential target APs such that the downlink data packet may be forwarded from the data buffer;
receiving, by the serving AP, a roaming request from the station, wherein the roaming request identifies a type of handover and comprises at least a target AP identifier (APID) field, a cause field identifying the type of handover, a serving APID field and an association identifier (AID) field;
transferring, by the serving AP, a station context transfer information associated with the station to an identified target AP from the one or more potential target APs based on establishing data session context transfer with the identified target AP; and
transmitting, by the serving AP, a roaming response to the station.

11. The method of claim 10, wherein the detecting of the trigger comprises:
monitoring a value of a key performance indicator (KPI), wherein the KPI indicates RSSI or SINR observed between the serving AP and the station;
comparing the value with a predetermined threshold value; and
detecting the trigger for the occurrence of the pre-roaming condition, when the value of the KPI is equal to or less than the predetermined threshold value.

12. The method of claim 10, further comprising:
upon the detecting of the trigger:
notifying the detected trigger to the station; and
receiving an acknowledgement of the notification from the station.

13. The method of claim 10, wherein the storing of the downlink data packet associated with the station comprises:
storing the downlink data packet in a data buffer for a predetermined time period such that the data buffer is common for each of the serving AP and the one or more potential target APs, wherein the data buffer along with the serving AP and the one or more potential target APs forms part of a common seamless mobility domain (SMD).

14. The method of claim 10, wherein the storing of the downlink data packet associated with the station comprises:
storing the downlink data packet in a data buffer corresponding to each of the one or more potential target APs for a predetermined time period, wherein the data buffer along with the serving AP and the one or more potential target APs forms part of a common seamless mobility domain (SMD).

15. The method (1900) as claimed in of claim 10, wherein the type of handover indicates one of a normal handover, a fast handover, and or a panic handover.

16. The method of claim 10, wherein the receiving of the roaming request comprises:
receiving the roaming request from the station, when the type of the handover indicates one of a normal handover and a fast handover.

17. The method of claim 10, wherein the transmitting of the roaming response comprises:
transmitting the roaming response to the station, when the type of the handover indicates one of a normal handover, and a fast handover, wherein the roaming response indicates a link configuration with the identified target AP after a context transfer and backend distribution system (DS) path update between the serving AP and the identified target AP.

18. The method of claim 10, wherein the transmitting of the roaming response comprises:
transmitting the roaming response followed by a conditional wait time period, when the type of handover is a normal handover.

19. The method of claim 10, further comprising:
transmitting a request to the identified target AP to resume a complete downlink data packet transmission with the station.

20. The method of claim 10, wherein the transmitting of the roaming response comprises:
transmitting the roaming response along with a deletion of a configured link with the station, when the type of handover is a fast handover.
